(19) United States
(12) Patent Application Publication
(10) Pub. No.: US 2024/0012996 A1
(43) Pub. Date: Jan. 11, 2024

(54) ALIGNMENT APPARATUS, LEARNING APPARATUS, ALIGNMENT METHOD, LEARNING METHOD AND PROGRAM

(71) Applicant: NIPPON TELEGRAPH AND TELEPHONE CORPORATION, Tokyo (JP)

(72) Inventors: Katsuki CHOSA, Tokyo (JP); Masaaki NAGATA, Tokyo (JP); Masaaki NISHINO, Tokyo (JP)

(21) Appl. No.: 18/253,829

(22) PCT Filed: Nov. 27, 2020
(86) PCT No.: PCT/JP2020/044373

§ 371 Date: May 22, 2023

(51) Int. Cl. G06F 40/284; G06F 40/53

(52) U.S. Cl. CPC G06F 40/284; G06F 40/53

(57) ABSTRACT

An alignment device includes a memory and a processor configured to execute generating a span prediction problem between first domain sequence information and second domain sequence information by receiving the first domain sequence information and the second domain sequence information as inputs; and using a span prediction model created using data including a cross-domain span prediction problem and an answer to the span prediction problem, and predicting a span to be an answer to the span prediction problem.

### TECHNICAL FIELD

The present invention relates to a technique for identifying a pair of sentence sets (one or a plurality of sentences) aligned with each other in two documents in an alignment relationship with each other.

### BACKGROUND ART

Identifying a pair of sentence sets aligned with each other in two documents in an alignment relationship with each other is called sentence alignment. A sentence alignment system generally includes a mechanism for calculating a similarity score between sentences of two documents, and a mechanism for identifying a sentence alignment of the entire document from sentence alignment possibilities obtained by the mechanism and the score.

### CITATION LIST

### Non Patent Literature

Non Patent Literature 1: Brian Thompson and Philipp Koehn. Vecalign: Improved sentence alignment in linear time and space. In Proceedings of EMNLP-2019, pp. 1342-1348, 2019.

### SUMMARY OF INVENTION

### Technical Problem

In the conventional technique that performs sentence alignment, context information is not used when similarity calculation between sentences is performed. Furthermore, in recent years, a method of performing similarity calculation by vector representation of a sentence by a neural network has achieved high accuracy, but in this method, information in units of words cannot be utilized well because a sentence is once converted into one vector representation. Thus, there is a problem of poor accuracy.

That is, in the conventional technique, it is not possible to accurately perform sentence alignment to identify a pair of sentence sets aligned with each other in two documents in an alignment relationship with each other. Note that such a problem is a problem that can occur in sequence information that is not limited to documents.

The present invention has been made in view of the above points, and an object thereof is to provide a technique capable of accurately performing alignment processing of identifying a pair of pieces of information aligning with each other in two pieces of sequence information.

### Solution to Problem

According to the disclosed technique, there is provided an alignment device including a problem generation unit that generates a span prediction problem between first domain sequence information and second domain sequence information by receiving the first domain sequence information and the second domain sequence information as inputs, and a span prediction unit that uses a span prediction model created using data including a cross-domain span prediction problem and an answer to the span prediction problem, and predicts a span to be an answer to the span prediction problem.

### Advantageous Effects of Invention

According to the disclosed technique, there is provided a technique capable of accurately performing alignment processing of identifying a pair of pieces of information aligning with each other in two pieces of sequence information.

### BRIEF DESCRIPTION OF DRAWINGS

FIG. 1 is a device configuration diagram in Example 1.

FIG. 2 is a flowchart illustrating an overall flow of processing.

FIG. 3 is a flowchart illustrating processing of training a cross-language span prediction model.

FIG. 4 is a flowchart illustrating processing of generating a sentence alignment.

FIG. 5 is a hardware configuration diagram of the device.

FIG. 6 is a diagram illustrating an example of sentence alignment data.

FIG. 7 is a diagram illustrating an average sentence number and a token number in each data set.

FIG. 8 is a diagram illustrating F₁ scores in the entire alignment relationship.

FIG. 9 is a diagram illustrating sentence alignment accuracy evaluated for each number of sentences of a source language and a target language in the alignment relationship.

FIG. 10 is a diagram illustrating a comparison result of translation accuracy when the amount of parallel translation sentence pairs used for training is changed.

FIG. 11 is a device configuration diagram in Example 2.

FIG. 12 is a flowchart illustrating an overall flow of processing.

FIG. 13 is a flowchart illustrating processing of training the cross-language span prediction model.

FIG. 14 is a flowchart illustrating word alignment generation processing.

FIG. 15 is a diagram illustrating an example of word alignment data.

FIG. 16 is a diagram illustrating an example of a question from English to Japanese.

FIG. 17 is a diagram illustrating an example of span prediction.

FIG. 18 is a diagram illustrating an example of symmetrization of word alignments.

FIG. 19 is a diagram illustrating the number of pieces of data used in an experiment.

FIG. 20 is a diagram illustrating a comparison between a conventional technique and a technique according to an embodiment.

FIG. 21 is a diagram illustrating an effect of symmetrization.

FIG. 22 is a diagram illustrating importance of a context of a source language word.

FIG. 23 is a diagram illustrating word alignment accuracy in a case where training is performed using a subset of Chinese and English training data.

### DESCRIPTION OF EMBODIMENTS

Hereinafter, embodiments of the present invention (present embodiments) will be described with reference to the drawings. The embodiments described below are merely examples, and embodiments to which the present invention is applied are not limited to the following embodiments.

Hereinafter, Example 1 and Example 2 will be described as the present embodiment. In Examples 1 and 2, the alignment is mainly described by taking a text pair between different languages as an example, but this is an example, and the present invention is not limited to the alignment of a text pair between different languages, and is also applicable to an alignment between different domains of a text pair of a same language. Examples of the alignment of a text pair of the same language include an alignment between colloquial sentences/words and business sentences/words, and the like.

Because languages are also a type of “domain”, the alignment of a text pair between different languages is an example of the alignment of a text pair between different domains.

In addition, each of a sentence, a document, and a writing is a sequence of tokens, and these may be referred to as sequence information. Furthermore, in the present description, the number of sentences that are elements of the “sentence set” may be plural or one.

### Example 1

First, Example 1 will be described. In Example 1, a problem for identifying sentence alignment is regarded as a set of problems (cross-language span prediction) for independently predicting a continuous sentence set (span) of a document in another language aligning with a continuous sentence set of a document in a certain language, a cross-language span prediction model is trained using a neural network from pseudo correct answer data created by an existing technique, and a prediction result thereof is mathematically optimized in a framework of a linear programming problem, thereby achieving a highly accurate sentence alignment. Specifically, a sentence alignment device 100 to be described later executes processing related to the sentence alignment. Note that a linear programming used in Example 1 is more specifically an integer linear programming. Unless otherwise specified, the “linear programming” used in Example 1 means “integer linear programming”.

In the following, first, a reference technique related to sentence alignment will be described in order to facilitate understanding of the technique according to Example 1. Thereafter, the configuration and operation of the sentence alignment device 100 according to Example 1 will be described.

Note that the numbers and document names of reference documents related to the reference technique and the like of Example 1 are collectively described at the end of Example 1. In the following description, numbers of related reference documents are indicated as “[1]” or the like.

### Example 1: Description of Reference Technique

As described above, the sentence alignment system generally includes a mechanism for calculating a similarity score between sentences of two documents, and a mechanism for identifying a sentence alignment of the entire document from sentence alignment possibilities obtained by the mechanism and the score.

With respect to the former mechanism, in the conventional method, similarity without considering the context is used on the basis of sentence length [1], bilingual dictionary [2, 3, and 4], machine translation system [5], multilingual sentence vector [6] (Non Patent Literature 1 described above), and the like. For example, Thompson et al. [6] propose a method of obtaining a multilingual sentence vector independent of language by a method called LASER and calculating a sentence similarity score from cosine similarity between the vectors.

Further, regarding the latter mechanism for identifying the sentence alignment of the entire document, a method based on dynamic programming (DP) assuming monotonicity of the sentence alignment is used in many conventional techniques such as the method of Thompson et al. [6] and Utiyama et al. [3].

Utiyama et al. [3] propose a sentence alignment method in which a score of document alignment is taken into consideration. In this method, a document in one language is translated into another language using a bilingual dictionary, and the documents are aligned based on BM25 [7]. Next, the sentence alignment is performed by alignment between inter-sentence similarity called SIM and DP from the obtained pair of documents. The SIM is defined by a bilingual dictionary between two documents on the basis of a relative frequency of words aligning on a one-to-one basis. In addition, an average of SIMs of sentence alignments in the aligning documents is used as score AVSIM indicating the reliability of document alignment, and a product of the SIM and the AVSIM is used as the final score of sentence alignment. Thus, it is possible to perform robust sentence alignment in a case where alignment of documents is not very accurate. This method is generally used as a sentence alignment method between English and Japanese.

### Example 1: Problem

In the conventional technique as described above, context information is not used when similarity calculation between sentences is performed. Furthermore, in recent years, methods of performing similarity calculation by vector representation of a sentence by the neural network have achieved high accuracy, but in these methods, information in units of words cannot be utilized well because a sentence is once converted into one vector representation. Thus, the accuracy of sentence alignment may be impaired.

In addition, in many conventional techniques, overall optimization is performed by dynamic programming assuming monotonicity of alignment relationship. However, the sentence alignment of an actual parallel translation document is not all monotonic. In particular, it is known that documents related to laws include a non-monotonic sentence alignment, and there is a problem that the method of the conventional technique deteriorates accuracy for such documents.

Hereinafter, a technique for solving the above-described problem and enabling highly accurate sentence alignment will be described as Example 1.

### Outline of Technique According To Example 1

In Example 1, first, a sentence alignment is converted into a problem of cross-language span prediction. A pre-trained multilingual language model using at least monolingual data related to a pair of languages to be handled is finetuned using pseudo sentence alignment correct answer data created by an existing method, thereby implementing cross-language span prediction. At this time, since a sentence of a certain document and another document are input to the model, it is possible to consider the context before and after the span at the time of prediction. Further, by using a model in which a structure called self-attention is used for the multilingual language model, information in units of words can be utilized.

Next, in order to identify a consistent alignment relationship in the entire document, the overall optimization is performed by the linear programming after score symmetrization is performed on sentence alignment possibilities by span prediction. Thus, the reliability of results of asymmetric cross-language span prediction can be improved, and non-monotonic sentence alignment can be identified. By such a method, the sentence alignment with high accuracy is achieved in Example 1.

(Device Configuration Example)

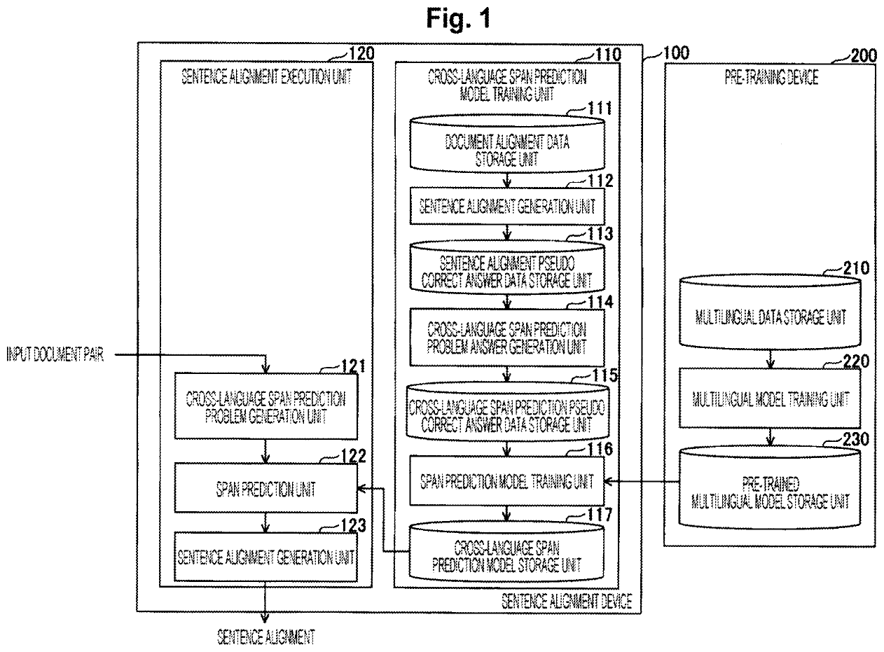

FIG. 1 illustrates a sentence alignment device 100 and a pre-training device 200 in Example 1. The sentence alignment device 100 is a device that executes sentence alignment processing by the technique according to Example 1. The pre-training device 200 is a device that trains a multilingual model from multilingual data. Note that both the sentence alignment device 100 and a word alignment device 300 to be described later may be referred to as “alignment device”.

As illustrated in FIG. 1, the sentence alignment device 100 has a cross-language span prediction model training unit 110 and a sentence alignment execution unit 120.

The cross-language span prediction model training unit 110 has a document alignment data storage unit 111, a sentence alignment generation unit 112, a sentence alignment pseudo correct answer data storage unit 113, a cross-language span prediction problem answer generation unit 114, a cross-language span prediction pseudo correct answer data storage unit 115, a span prediction model training unit 116, and a cross-language span prediction model storage unit 117. Note that the cross-language span prediction problem answer generation unit 114 may be referred to as a problem answer generation unit.

The sentence alignment execution unit 120 has a cross-language span prediction problem generation unit 121, a span prediction unit 122, and a sentence alignment generation unit 123. Note that the cross-language span prediction problem generation unit 121 may be referred to as a problem generation unit.

The pre-training device 200 is a device according to an existing technique. The pre-training device 200 has a multilingual data storage unit 210, a multilingual model training unit 220, and a pre-trained multilingual model storage unit 230. The multilingual model training unit 220 reads monolingual texts of at least two languages or domains for which the sentence alignment is to be obtained from the multilingual data storage unit 210 to train a language model, and stores the language model as a pre-trained multilingual model in the pre-trained multilingual model storage unit 230.

In Example 1, since it is sufficient if the pre-trained multilingual model trained by some means is input to the cross-language span prediction model training unit 110, for example, a general-purpose pre-trained multilingual model disclosed to the public may be used without having the pre-training device 200.

The pre-trained multilingual model in Example 1 is a language model trained in advance using a monolingual text of each language for which at least the sentence alignment is to be obtained. In the present embodiment, XLM-RoBERTa is used as the language model, but the language model is not limited thereto. Any language model may be used as long as it is the pre-trained multilingual model that can be predicted in consideration of word-level information and context information for multilingual text, such as Multilingual BERT. In addition, although the model is called a “multilingual model” because it can support multiple languages, it is not essential to perform training in multiple languages, and for example, pre-training may be performed using texts of a plurality of different domains of the same language.

Note that the sentence alignment device 100 may be referred to as a learning device. In addition, the sentence alignment device 100 may include the sentence alignment execution unit 120 without including the cross-language span prediction model training unit 110. Further, a device in which the cross-language span prediction model training unit 110 is provided alone may be referred to as a learning device.

(Outline of Operation of Sentence Alignment Device 100)

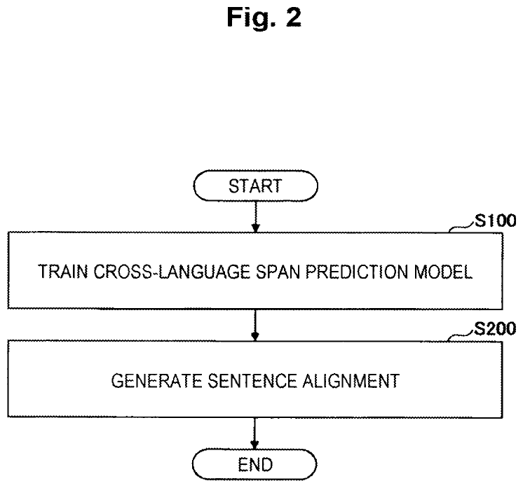

FIG. 2 is a flowchart illustrating an entire operation of the sentence alignment device 100. In S100, the pre-trained multilingual model is input to the cross-language span prediction model training unit 110, and the cross-language span prediction model training unit 110 trains a cross-language span prediction model on the basis of the pre-trained multilingual model.

In S200, the cross-language span prediction model trained in S100 is input to the sentence alignment execution unit 120, and the sentence alignment execution unit 120 generates and outputs the sentence alignment in an input document pair using the cross-language span prediction model.

<S100>

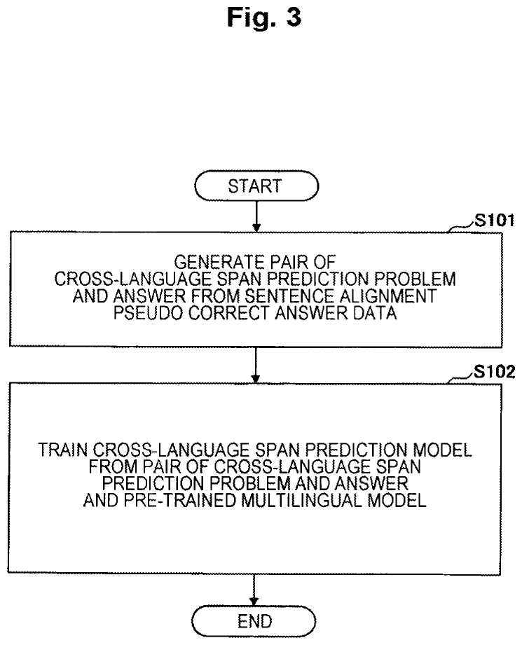

With reference to a flowchart of FIG. 3, processing of training the cross-language span prediction model in the above-described S100 will be described. As a premise of the flowchart of FIG. 3, it is assumed that the pre-trained multilingual model has already been input, and the pre-trained multilingual model is stored in the storage device of the cross-language span prediction model training unit 110. Further, it is assumed that the sentence alignment pseudo correct answer data storage unit 111 stores sentence alignment pseudo correct answer data.

In S101, the cross-language span prediction problem answer generation unit 114 reads the sentence alignment pseudo correct answer data from the sentence alignment pseudo correct answer data storage unit 113, generates cross-language span prediction pseudo correct answer data, that is, a pair of a cross-language span prediction problem and a pseudo answer thereof from the read sentence alignment pseudo correct answer data, and stores the data in the cross-language span prediction pseudo correct answer data storage unit 113.

Here, for example, in a case where the sentence alignment is obtained between the first language and the second language, the pseudo correct answer data of the sentence alignment has a document of the first language, a document of the second language aligning therewith, and data indicating alignment between a sentence set of the first language and a sentence set of the second language. The data indicating the alignment between the sentence set of the first language and the sentence set of the second language is, for example, data indicating alignment in which (sentence 1 and sentence 2) and (sentence 6 and sentence 7) are aligned and (sentence 1 and sentence 2) and (sentence 5 and sentence 6) are aligned in a case where document of the first language=(sentence 1, sentence 2, sentence 3, and sentence 4) and document of the second language=(sentence 5, sentence 6, sentence 7, and sentence 8).

As described above, the pseudo correct answer data of the sentence alignment is used in Example 1. The pseudo correct answer data of the sentence alignment is obtained by the sentence alignment using an existing method from data of a pair of documents which are aligned manually or automatically.

In the configuration example illustrated in FIG. 1, data of a pair of manually or automatically aligned documents is stored in the document alignment data storage unit 111. The data is document alignment data including the same language (or domain) as the document pair for which sentence alignment is obtained. The sentence alignment generation unit 112 generates the sentence alignment pseudo correct answer data from the document alignment data by an existing method. More specifically, sentence alignment is obtained using the technique of Utiyama et al. [3] described in the reference technique. That is, the sentence alignment is obtained by alignment between the inter-sentence similarity called SIM and DP from the document pair.

Note that, instead of the sentence alignment pseudo correct answer data, the sentence alignment correct answer data created manually may be used. In addition, the “pseudo correct answer data” and the “correct answer data” may be collectively referred to as “correct answer data”.

In S102, the span prediction model training unit 116 trains the cross-language span prediction model from the cross-language span prediction pseudo correct answer data and the pre-trained multilingual model, and stores the trained cross-language span prediction model in the cross-language span prediction model storage unit 117.

<S200>

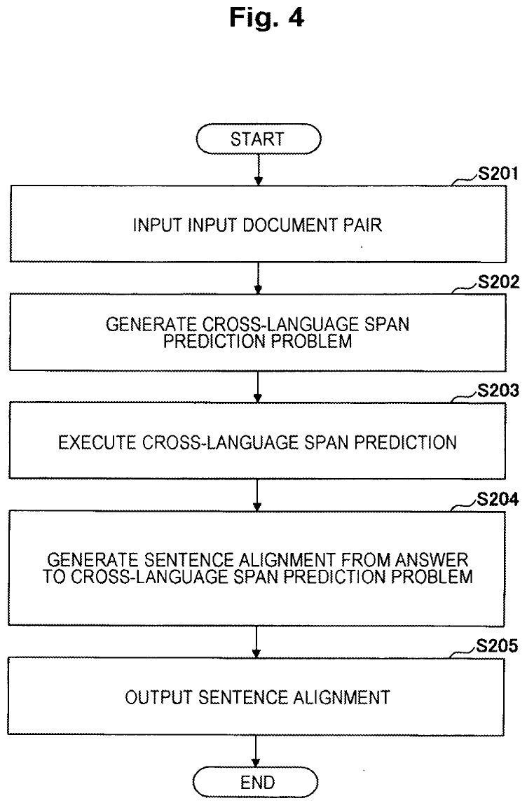

Next, content of processing of generating the sentence alignment in the above-described S200 will be described with reference to a flowchart of FIG. 4. Here, it is assumed that the cross-language span prediction model has already been input to the span prediction unit 122 and stored in a storage device of the span prediction unit 122.

In S201, the document pair is input to the cross-language span prediction problem generation unit 121. In S202, the cross-language span prediction problem generation unit 121 generates a cross-language span prediction problem from the input document pair.

Next, in S203, the span prediction unit 122 performs span prediction on the cross-language span prediction problem generated in S202 using the cross-language span prediction model, and obtains an answer.

In S204, the sentence alignment generation unit 123 generates the sentence alignment by performing the overall optimization from the answer to the cross-language span prediction problem obtained in S203. In S205, the sentence alignment generation unit 123 outputs the sentence alignment generated in S204.

Note that the “model” in the present embodiment is a model of the neural network, and specifically includes a weight parameter, a function, and the like.

(Hardware Configuration Example)

Both the sentence alignment device and the learning device in Example 1 and the word alignment device and the learning device in Example 2 (these devices are collectively referred to as “devices”) can be achieved by, for example, causing a computer to execute a program describing processing contents described in the present embodiment (Example 1 and Example 2). Note that the “computer” may be a physical machine or a virtual machine on a cloud. In a case where a virtual machine is used, “hardware” described herein is virtual hardware.

The above program can be stored and distributed by being recorded in a computer-readable recording medium (portable memory or the like). Furthermore, the above program can also be provided through a network such as the Internet or an electronic mail.

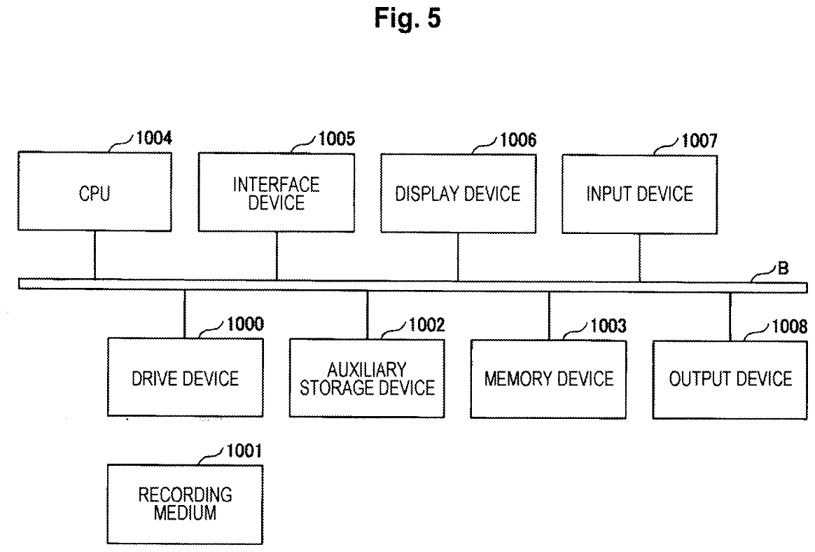

FIG. 5 is a diagram illustrating a hardware configuration example of the computer. The computer in FIG. 5 includes a drive device 1000, an auxiliary storage device 1002, a memory device 1003, a CPU 1004, an interface device 1005, a display device 1006, an input device 1007, an output device 1008, and the like which are connected to each other by a bus B.

The program for implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is made, the memory device 1003 reads and stores the program from the auxiliary storage device 1002. The CPU 1004 implements a function related to the device in accordance with a program stored in the memory device 1003. The interface device 1005 is used as an interface for connecting to the network. The display device 1006 displays a graphical user interface (GUI) or the like by the program. The input device 1007 includes a keyboard and mouse, buttons, a touch panel, or the like, and is used to input various operation instructions. The output device 1008 outputs a calculation result.

### Example 1: Description of Specific Processing Content

Hereinafter, content of processing of the sentence alignment device 100 in Example 1 will be described more specifically.

<Formulation from Sentence Alignment to Span Prediction>

In Example 1, sentence alignment is formulated as a cross-language span prediction problem similar to a question answering task in SQuAD format [8]. Accordingly, first, formulation from sentence alignment to span prediction will be described using an example. In the context of the sentence alignment device 100, here, the cross-language span prediction model and training thereof in the cross-language span prediction model training unit 110 are mainly described.

The question answering system that performs the question answering task in the SQuAD format is given a “context” and a “question” of a paragraph selected from Wikipedia, or the like, and the question answering system predicts a “span” in the context as an “answer”.

Similarly to the span prediction described above, the sentence alignment execution unit 120 in the sentence alignment device 100 of Example 1 regards a target language document as the context, regards a sentence set in a source language document as the question, and predicts a sentence set in the target language document, which is a translation of the sentence set of the source language document, as the span of the target language document. For this prediction, the cross-language span prediction model in Example 1 is used.

—Cross-language Span Prediction Problem Answer Generation Unit 114—

In Example 1, the cross-language span prediction model training unit 110 of the sentence alignment device 100 performs supervised learning of the cross-language span prediction model, but correct answer data is necessary for learning. In Example 1, the cross-language span prediction problem answer generation unit 114 generates the correct answer data from the sentence alignment pseudo correct answer data as pseudo correct answer data.

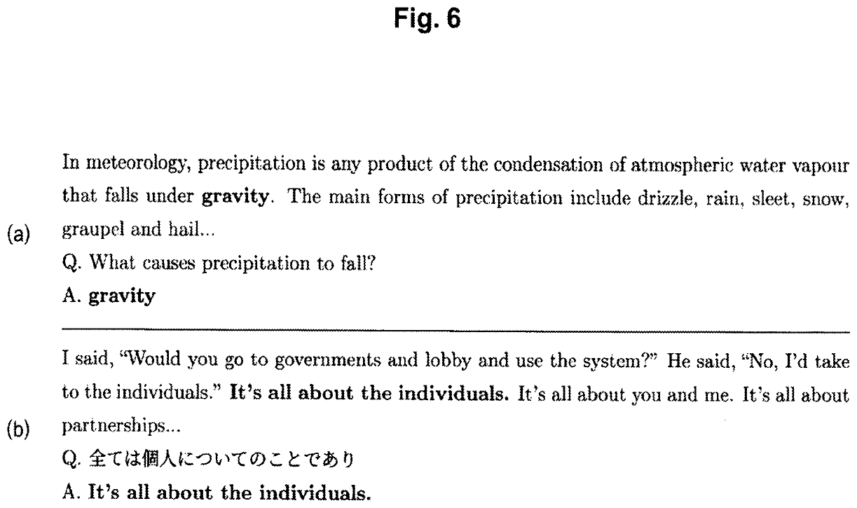

FIG. 6 illustrates an example of a cross-language span prediction problem and an answer in Example 1. FIG. 6(a) illustrates a monolingual question answering task in the SQuAD format, and FIG. 6(b) illustrates a sentence alignment task from a parallel translation document.

The cross-language span prediction problem and the answer illustrated in FIG. 6(a) include a document and a question (Q), and an answer (A) thereto. The cross-language span prediction problem and the answer illustrated in FIG. 6(b) include English documents and Japanese questions (Q), and an answer (A) to the question (Q).

As an example, assuming that the target document pair is an English document and a Japanese document, the cross-language span prediction problem answer generation unit 114 illustrated in FIG. 1 generates a plurality of sets of a document (context) and a question and an answer as illustrated in FIG. 6(b) from the sentence alignment pseudo correct answer data.

As will be described later, in Example 1, the span prediction unit 122 of the sentence alignment execution unit 120 performs prediction for each direction of prediction from the first language document (question) to the second language document (answer) and prediction from the second language document (question) to the first language document (answer) using the cross-language span prediction model. Therefore, bidirectional pseudo correct answer data may be generated and bidirectional training may be performed so that prediction can be performed bidirectionally as described above also at the time of training the cross-language span prediction model.

Note that performing bidirectional prediction as described above is an example. The prediction in one direction of only prediction from the first language document (question) to the second language document (answer) or only prediction from the second language document (question) to the first language document (answer) may be performed.

—Definition of Cross-Language Span Prediction Problem—

The definition of the cross-language span prediction problem in Example 1 will be described in more detail. Let F={f₁, f₂, . . . , f_{N};) be a source language document F including a token of length N, and let E={e₁, e₂, . . . , e_{M}} be a target language document E including a token of length M.

The cross-language span prediction problem in Example 1 is to extract a target language text R={ex, eₖ₊₁, . . . , e₁} of a span (k, l) in the target language document E with respect to a source language sentence Q=(fᵢ, fᵢ₊₁, . . . , fⱼ} including i-th to j-th tokens in the source language document F. Note that the “source language sentence Q” may be one sentence or a plurality of sentences.

In the sentence alignment in Example 1, not only one sentence and one sentence can be aligned, but also a plurality of sentences and a plurality of sentences can be aligned. In Example 1, any continuous sentence in the source language document is input as the source language sentence Q, so that one-to-one and many-to-many alignment can be handled in the same framework.

—Span Prediction Model Training Unit 116—

The span prediction model training unit 116 trains the cross-language span prediction model using the pseudo correct answer data read from the cross-language span prediction pseudo correct answer data storage unit 115. That is, the span prediction model training unit 116 inputs the cross-language span prediction problem (question and context) to the cross-language span prediction model, and adjusts parameters of the cross-language span prediction model so that an output of the cross-language span prediction model becomes a correct answer (pseudo correct answer). This adjustment of parameters can be performed by existing techniques.

The trained cross-language span prediction model is stored in the cross-language span prediction model storage unit 117. In addition, the sentence alignment execution unit 120 reads the cross language span prediction model from the cross-language span prediction model storage unit 117, and inputs the cross-language span prediction model to the span prediction unit 122.

—Pre-trained Model BERT—

Here, a pre-trained model BERT that is assumed to be used as the pre-trained multilingual model in Example 1 will be described. BERT [9] is a language representation model that outputs a word embedding vector considering preceding and following contexts for each word of an input sequence using an encoder based on a Transformer. Typically, the input sequence is obtained by connecting one sentence or two sentences with a special symbol interposed therebetween.

In BERT, the language representation model is pre-trained from large-scale language data using a task of training a masked language model that predicts a word masked in the input sequence from both forward and backward directions and a next sentence prediction task that determines whether or not two given sentences are adjacent sentences. By using such a pre-training task, BERT can output a word embedding vector in which a characteristic related to a linguistic phenomenon extending not only within one sentence but also across two sentences is captured. Note that a language representation model such as BERT may be simply referred to as a language model.

It has been reported that when an appropriate output layer is added to the pre-trained BERT and finetuned with learning data of a target task, the highest accuracy can be achieved in various tasks such as textual semantic similarity, natural language inference (text entailment recognition), question answering, and unique expression extraction. Note that the above-described finetuning is, for example, training of a target model using a parameter of the pre-trained BERT as an initial value of the target model (a model obtained by adding an appropriate output layer to BERT).

In a task in which a pair of sentences such as semantic text similarity, natural language inference, and question answering are received as inputs, a sequence in which two sentences are connected using special symbols, such as ‘[CLS]first sentence[SEP]second sentence[SEP]’, is given as an input to BERT. Here, [CLS] is a special token for creating a vector that aggregates information of two input sentences, and is called a classification token, and [SEP] is a token representing a sentence separation, and is called a separator token.

In a task of predicting a span of another sentence on the basis of one sentence for two input sentences like question answering (QA), whether or not there is a span to be extracted in the other sentence is predicted from a vector output by BERT for [CLS], and a probability that the word will be a start point of a span to be extracted and a probability that the word will be an end point of the span to be extracted are predicted from a vector output by BERT for each word of the other sentence.

BERT was originally created for English, but currently, BERT for various languages including Japanese has been created and opened to the public. In addition, a general-purpose multilingual model Multilingual BERT created by extracting monolingual data of 104 languages from Wikipedia and using the monolingual data is publicly available.

Furthermore, a cross-language language model XLM pre-trained by a masked language model using parallel translation sentences has been proposed, and it has been reported to have higher accuracy than Multilingual BERT in applications such as cross-language text classification, and a pre-trained model is generally disclosed.

—Cross-language Span Prediction Model—

The cross-language span prediction model in Example 1 selects a span (k, l) of the target language text R aligning with the source language sentence Q from the target language document E at the time of training and at the time of sentence alignment execution.

The sentence alignment generation unit 123 (or the span prediction unit 122) of the sentence alignment execution unit 120 calculates an alignment score ωᵢⱼₖₗ from the span (i, j) of the source language sentence Q to the span (k, l) of the target language text R using the product of the probability p₁ at the start position and the probability p₂ at the end position as follows.

[Math. 1]

ωᵢⱼₖₗ=softmax(p₁(k|E,Q)·p₂(l|E,Q)) (1)

For the calculation of p₁ and p₂, a pre-trained multilingual model based on BERT [9] described above is used in Example 1. Although these models have been created for monolingual language understanding tasks in multiple languages, they work surprisingly well for cross-language tasks as well.

The source language sentence Q and the target language document E are combined with each other, and one piece of sequence data as follows is input to the cross-language span prediction model of Example 1.

[CLS]Source Language Sentence Q[SEP]Target Language Document E[SEP]

The cross-language span prediction model of Example 1 is a model obtained by finetuning with the learning data of a task that predicts a span between a target language document and a source language document for the pre-trained multilingual model to which two independent output layers are added. These output layers predict the probability p₁ of each token position in the target language document to be the start position of the answer span or the probability p₂ of each token position to be the end position of the answer span.

<Span Prediction>

Next, an operation of the sentence alignment execution unit 120 will be described in detail.

—Cross-language Span Prediction Problem Generation Unit 121 and Span Prediction Unit 122—

The cross-language span prediction problem generation unit 121 generates a span prediction problem in the format of “[CLS]source language Q[SEP]target language document E[SEP]” for each source language sentence Q for an input document pair (source language document and target language document), and outputs the span prediction problem to the span prediction unit 122.

As will be described later, since bidirectional prediction is performed in Example 1, assuming that the document pair is the first language document and the second language document, a problem of span prediction from the first language document (question) to the second language document (answer) and a problem of span prediction from the second language document (question) to the first language document (answer) may be generated by the cross-language span prediction problem generation unit 121.

The span prediction unit 122 calculates an answer (predicted span) and probabilities p₁ and p₂ for each question by inputting each problem (question and context) generated by the cross-language span prediction problem generation unit 121, and outputs the answer (predicted span) and the probabilities p₁ and p₂ for each question to the sentence alignment generation unit 123.

—Sentence Alignment Generation Unit 123—

For example, the sentence alignment generation unit 123 can select the best answer span (\hat{ }k, \hat{ }l) for the source language sentence as a span that maximizes the alignment score ωᵢⱼₖₗ as follows. The sentence alignment generation unit 123 may output a selection result thereof and the source language sentence as the sentence alignment.

$$\\ \begin{matrix}[ Math . 2 ] & \\ ( \hat{k} , \hat{l} ) = {arg max}_{( k , l ) : 1 \leq k \leq l \leq M} {ω}_{ijkl} & ( 2 )\end{matrix}$$

However, in an actual parallel translation document (the document pair input to the sentence alignment execution unit 120), there may be a case where an absence of a position aligning with the source language sentence Q of the document of a certain language in the other document exists as a noise. Accordingly, in Example 1, whether the target language text aligning with the source language sentence exists can be determined.

More specifically, in Example 1, the sentence alignment generation unit 123 calculates a non-alignment score φᵢⱼ using the value predicted at the position of “[CLS]”, and can determine whether the aligning target language text exists according to the magnitude of the alignment score ωᵢⱼₖₗ between the score and the span. For example, the sentence alignment execution unit 120 may not use a source language sentence in which no aligning target language text exists as the source language sentence for sentence alignment generation.

Here, “calculating the non-alignment score φᵢⱼ using the value predicted at the position of “[CLS]”” substantially corresponds to that the alignment score ωᵢⱼₖₗ in a case where (start position and end position) of “[CLS]” in the sequence data input to the cross-language span prediction model is regarded as the answer span is set as the score φᵢⱼ.

Although the answer span predicted by the cross-language span prediction model does not necessarily match the sentence boundary in the document, it is necessary to convert a prediction result into a sentence sequence in order to perform optimization and evaluation for sentence alignment. Accordingly, in Example 1, the sentence alignment generation unit 123 obtains a sequence of the longest sentence completely included in the predicted answer span, and sets the sequence as the prediction result at the sentence level.

—Optimization of Prediction Span by Linear Programming by Sentence Alignment Generation Unit 123—

Next, an example of a method for accurately identifying a many-to-many alignment relationship from the above-described alignment score, which is executed by the sentence alignment generation unit 123, will be described. Hereinafter, problems with the method and detailed processing of the method will be described.

<Problem>

There are the following problems in a case of directly using the sentence alignment (for example, the sentence alignment obtained by Expression (2)) obtained by the cross-language span prediction using the cross-language span prediction model.
Overlap of spans occurs in many predicted alignment relationships because the cross-language span prediction model independently predicts the span of the target language text.
Although it is very important to determine the span of the source language sentence to be input in identifying the many-to-many alignment relationship, a method for selecting an appropriate span is not obvious.

<Details of Alignment Relationship Identification Method>

In order to solve these problems, the linear programming is introduced in Example 1. The overall optimization by the linear programming can ensure span consistency and maximize the score of alignment relationship across documents. According to a preliminary experiment, higher accuracy is achieved by converting the score into cost and minimizing the cost than by maximizing the score, and thus, in Example 1, formulation is performed as a minimization problem.

In addition, since the cross-language span prediction problem is asymmetric as it is, in Example 1, a similar alignment score ω′ᵢⱼₖₗ and non-alignment score φ′ₖₗ are calculated by switching the source language document and the target language document and solving a similar span prediction problem, and prediction results in two directions at the maximum are obtained for the same alignment relationship. Symmetrization using both scores in two directions can be expected to improve reliability of a prediction result and improve accuracy of sentence alignment.

In a case where the first language document is the source language document and the second language document is the target language document, the alignment score from the span (i, j) of a source language sentence of the first language document to the span (k, l) of a target language text of the second language document is ωᵢⱼₖₗ, and assuming that the second language document is the source language document and the first language document is the target language document, the alignment score from the span (k, l) of the source language sentence of the second language document to the span (i, j) of the target language text of the first language document is ω′ᵢⱼₖₗ. Further, φᵢⱼ is a score indicating that there is no span of the second language document aligning with the span (i, j) of the first language document, and φ′ₖₗ is a score indicating that there is no span of the first language document aligning with the span (k, l) of the second language document.

In the present embodiment, a score symmetrized in the form of a weighted average of ωᵢⱼₖₗ and ω′ᵢⱼₖₗ is defined as follows.

[Math. 3]

ωᵢⱼₖₗ=λωᵢⱼₖₗ+(1−λ)ω′ᵢⱼₖₗ (3)

In Expression 3 described above, λ is a hyperparameter, and the score is unidirectional when λ=0 or λ=1 and bidirectional when λ=0.5.

In Example 1, sentence alignment is defined as a set of span pairs having no overlap of spans in each document, and the sentence alignment generation unit 123 performs identification of sentence alignment by solving a problem of finding a set with a minimum sum of costs of the alignment relationship by the linear programming. Formulation of the linear programming in Example 1 is as follows.

$$\\ \begin{matrix}[ Math . 4 ] & \\ Minimize {\sum }_{ijkl} {c}_{ijkl} {y}_{ijkl} + {\sum }_{ij} {ϕ}_{ij} {b}_{ij} + {\sum }_{kl} {ϕ}_{kl}^{′} {b}_{kl}^{′} & ( 4 )\end{matrix}$$

$$\\ \begin{matrix}[ Math . 5 ] & \\ Subject to {y}_{ijkl} , {b}_{ij} , {b}_{kl}^{′} ∈ \{ 0 , 1 \} & ( 5 )\end{matrix}$$

$$\\ \begin{matrix}[ Math . 6 ] & \\ {\sum }_{i \leq x \leq j} [ {b}_{ij} + {\sum }_{kl} {y}_{ijkl} ] = 1 , ∀ x : 1 \leq x \leq N & ( 6 )\end{matrix}$$

$$\\ \begin{matrix}[ Math . 7 ] & \\ {\sum }_{k \leq x \leq l} [ {b}_{kl}^{′} + {\sum }_{ij} {y}_{ijkl} ] = 1 , ∀ x : 1 \leq x \leq M & ( 7 )\end{matrix}$$

cᵢⱼₖₗ in Expression (4) described above is the cost of the alignment relationship calculated from ωᵢⱼₖₗ by Expression (8) described later, and is such a cost that the score ωᵢⱼₖₗ of the alignment relationship decreases and increases as the number of sentences included in the span increases.

yᵢⱼₖₗ is a binary variable representing whether the spans (i, j) and (k, l) are in an alignment relationship, and when the value is 1, it is determined to be aligned. bᵢⱼ and b′ₖₗ are binary variables respectively indicating whether or not the spans (i, j) and (k, l) are non-alignment, and when the value is 1, it is determined that there is no alignment. Both Σφᵢⱼbᵢⱼ and Σφ′ₖₗb′ₖₗ in Expression (4) are costs that increase as the number of cases of non-alignment increases.

Expression (6) is a constraint that ensures, for each sentence in the source language document, that the sentence appears only in one span pair in the alignment relationship. Further, Expression (7) is a similar restriction on the target language document. These two constraints ensure that there is no overlap of spans in each document and that each sentence is associated with some alignment relationship including no alignment.

In Expression (6), any x corresponds to any source language sentence. Expression (6) means that, for all spans including any source language sentence x, a constraint that the total sum of alignment with a target language span for those spans and a pattern in which x has no alignment is 1 is imposed on all source language sentences. This similarly applies to Expression (7).

The cost cᵢⱼₖₗ of the alignment relationship is calculated from the score Ω as follows:

$$\\ \begin{matrix}[ Math . 8 ] & \\ {c}_{ijkl} = \frac{n Sents ( i , j ) + nSents ( k , l )}{2} ( 1 - {Ω}_{ijkl} ) & ( 8 )\end{matrix}$$

nSents(i, j) in Expression (8) described above represents the number of sentences included in the span (i, j). A coefficient defined as an average of the sum of the numbers of sentences serves to suppress extraction of many-to-many alignment relationship. This alleviates a situation in which, when there is a plurality of one-to-one alignment relationships, consistency of the alignment relationship is impaired if they are extracted as one many-to-many alignment relationship.

The span possibilities of the target language text obtained when one source language sentence is input and its score ωᵢⱼₖₗ are present as many as the number proportional to the square of the number of tokens of the target language document. A calculation cost becomes very large if all of them are calculated as possibilities, and thus, in Example 1, only a small number of possibilities having high scores with respect to each source language sentence are used for optimization calculation by the linear programming. For example, N (N≥1) may be set in advance, and N possibilities in descending order of score may be used for each source language sentence.

In the preliminary experiment, sentence alignment accuracy was not improved even when the number of possibilities to be used for each input was increased from one, and thus, in the experiment described later, only the possibility having the highest score was used as the span possibility for each source language sentence.

—Filtering of Low Quality Data in Consideration of Document Alignment Information—

When parallel translation sentence data extracted by sentence alignment is actually used in a downstream task, a low-quality parallel translation sentence is often removed according to the sentence alignment score or cost. One of the causes of this low-quality alignment relationship is that the alignment relationship between automatically extracted parallel translation documents may be incorrect, and reliability is not high. However, the sentence alignment score and cost described so far do not take the accuracy of document alignment into consideration.

Accordingly, in Example 1, a document alignment cost d may be introduced, and the sentence alignment generation unit 123 may remove the low-quality parallel translation sentence according to the product of the document alignment cost d and a sentence alignment cost cᵢⱼₖₗ. The document alignment cost d is calculated as follows by dividing Expression (4) by the number of extracted sentence alignments.

$$[ Math . 9 ]$$

$$d = \frac{{\sum }_{ijkl} {c}_{ijkl} {y}_{ijkl} + {\sum }_{ij} {ϕ}_{ij} {b}_{ij} + {\sum }_{kl} {ϕ}_{kl}^{′} {b}_{kl}^{′}}{{\sum }_{ijkl} {y}_{ijkl} + {\sum }_{ij} {b}_{ij} + {\sum }_{kl} {b}_{kl}^{′}} \qquad ( 9 )$$

In a case where the sum of costs of the alignment relationship is large and the number of extracted sentence alignments is small, d is large. When d is large, it can be estimated that the accuracy of the document alignment is poor.

With regard to removing low-quality parallel translation sentences, for example, a document 1 of the first language and a document 2 of the second language are input to the sentence alignment execution unit 120, and the sentence alignment generation unit 123 obtains one or more pieces of parallel translation sentence data of aligned sentences. For example, the sentence alignment generation unit 123 determines that the obtained parallel translation sentence data in which d×cᵢⱼₖₗ is larger than a threshold has low quality, and does not use (removes) this parallel translation sentence data. In addition to such processing, only a certain number of pieces of the parallel translation sentence data may be used in ascending order of the value of d×cᵢⱼₖₗ.

### Effects of Example 1

With the sentence alignment device 100 described in Example 1, sentence alignment with higher accuracy than before can be achieved. The extracted parallel translation sentence contributes to improvement of translation accuracy of a machine translation model. Hereinafter, experiments on sentence alignment accuracy and machine translation accuracy exhibiting these effects will be described below. Hereinafter, an experiment on sentence alignment accuracy will be described as Experiment 1, and an experiment on machine translation accuracy will be described as Experiment 2.

### Experiment 1: Comparison of Sentence Alignment Accuracy

Evaluation was performed with the sentence alignment accuracy of Example 1 using actual automatic parallel translation documents of Japanese and English newspaper articles. In order to check a difference in accuracy due to a difference in optimization methods, results of cross-language span prediction were optimized by two methods of dynamic programming (DP) [1] and the linear programming (ILP, method of Example 1), and comparison was performed. Further, on a baseline, the method of Thompson et al. [6], which has achieved the highest accuracy in various languages, and the method of Utiyama et al. [3], which is a de facto standard method between Japanese and English, were used.

As the evaluation scale, F₁ score, which is a general scale in sentence alignment, was used. Specifically, the value of strict in the script of “https://github.com/thompsonb/vecalign/blob/master/score.py” was used. This scale is calculated according to the number of exact matches between the correct answer and prediction alignment relationship. On the other hand, despite that the automatically extracted parallel translation documents include sentences having no alignment relationship as noise, this scale does not directly evaluate extraction accuracy of sentences having no alignment relationship. Accordingly, in order to perform more detailed analysis, evaluation was also performed by the Precision/Recall/F₁ score for each number of sentences of the source language and the target language of the alignment relationship.

### Experiment 1: Experiment Data

For Experiment 1, newspaper articles of The Daily Yomiuri and its English version, The Japan News (formerly The Daily Yomiuri), were purchased and used. A sentence alignment data set was automatically and manually created from these data.

First, from 317,491 articles in Japanese and 3,878 articles in English published in 2012, 2,989 pieces of document alignment data were automatically created using the method of Utiyama et al. [3]. Sentence alignment was performed on the document alignment data using the method of Utiyama et al. [3], and the sentence alignment pseudo correct answer data was used as learning data of the cross-language span prediction model.

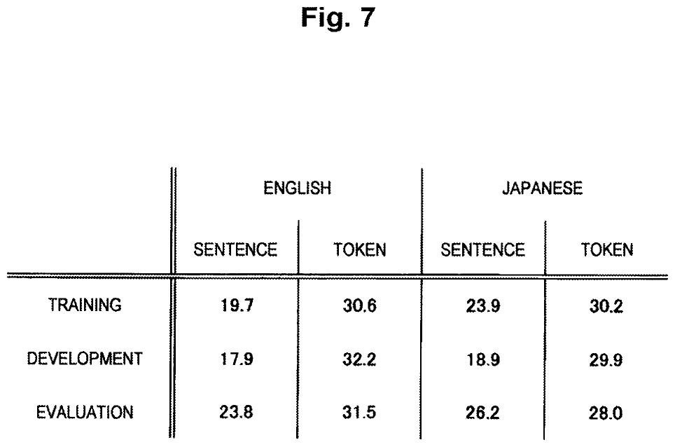

For the data for development and evaluation, 157 parallel translation documents including 131 articles and 26 editorials were created by manually searching for corresponding Japanese articles from 182 English articles between 2013/02/01-2013/02/07 and 2013/08/01-2013/08/07. Next, the sentence alignment was manually performed from each parallel translation document, and 2,243 pieces of many-to-many sentence alignment data were obtained. In this experiment, 15 articles of the data were for development, another 15 articles were for evaluation, and the remaining data were reserved. FIG. 7 illustrates an average number of sentences and the number of tokens in each data set.

### Experiment 1: Experiment Results

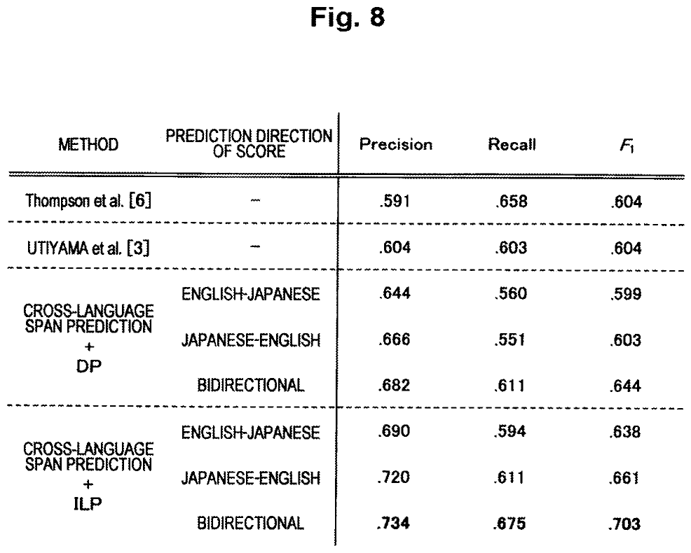

FIG. 8 illustrates F₁ scores in the entire alignment relationship. Results of the cross-language span prediction indicate higher accuracy than the baseline regardless of the optimization method. From this, it can be seen that the extraction of sentence alignment possibilities by the cross-language span prediction and the score calculation work more effectively than the baseline. In addition, results using bidirectional scores are better than results using only unidirectional scores, and thus it can be confirmed that the symmetrization of the score is very effective for sentence alignment. Next, comparing the scores of DP and ILP, ILP achieves much higher accuracy. From this, it can be seen that the optimization by ILP enables identification of sentence alignment better than the optimization by DP assuming monotonicity.

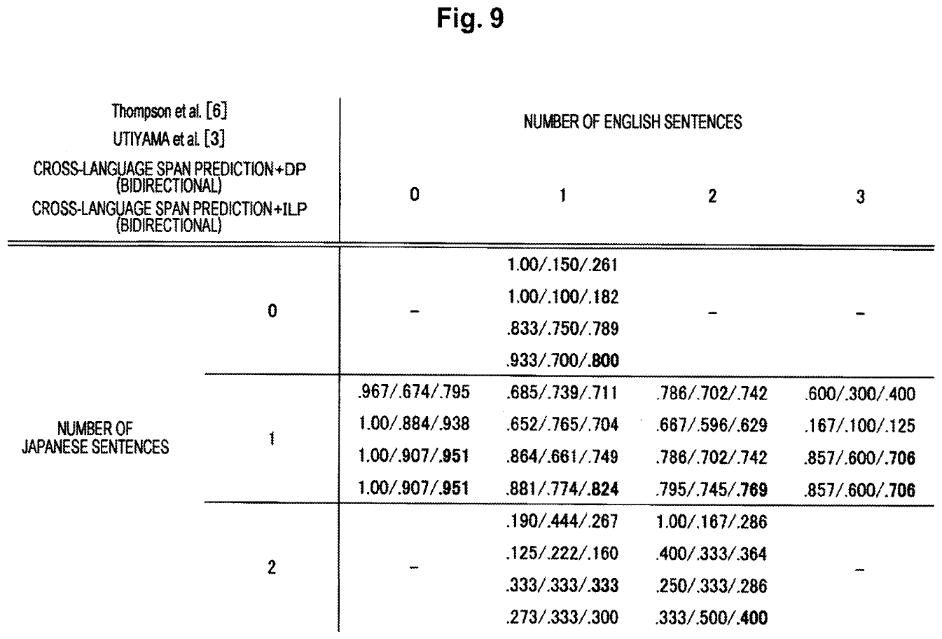

FIG. 9 illustrates sentence alignment accuracy evaluated for each number of sentences of the source language and the target language in the alignment relationship. In FIG. 9, a value of N rows and M columns represents a Precision/Recall/F₁ score of N to M alignment relationship. Further, a hyphen indicates that the alignment relationship does not exist in a test set.

In this case as well, the sentence alignment result by the cross-language span prediction exceeds the baseline result in all pairs. Furthermore, except for the one-to-two alignment relationship, the accuracy in the optimization by ILP is higher than that by DP. In particular, the F₁ scores for sentences with no alignment relationship (1 to 0 and 0 to 1) are as very high as 80.0 and 95.1, and a very large improvement can be seen when compared to the baseline. This result indicates that the technique of Example 1 can identify sentences that are in alignment relationship with very high accuracy, and is very effective in parallel translation documents including such sentences.

Note that, in this experiment, an NVIDIA Tesla K80 (12 GB) was used. In the test set, the time taken to predict the span for each input was about 1.9 seconds, and the average time taken to optimize for the document by the linear programming was 0.39 seconds. Conventionally, from the viewpoint of a time calculation amount, the dynamic programming having a calculation amount smaller than that of the linear programming has been used, but from these results, it is can be seen that the optimization can be performed in a practical time also in the linear programming.

### Experiment 2: Comparison with Machine Translation Accuracy

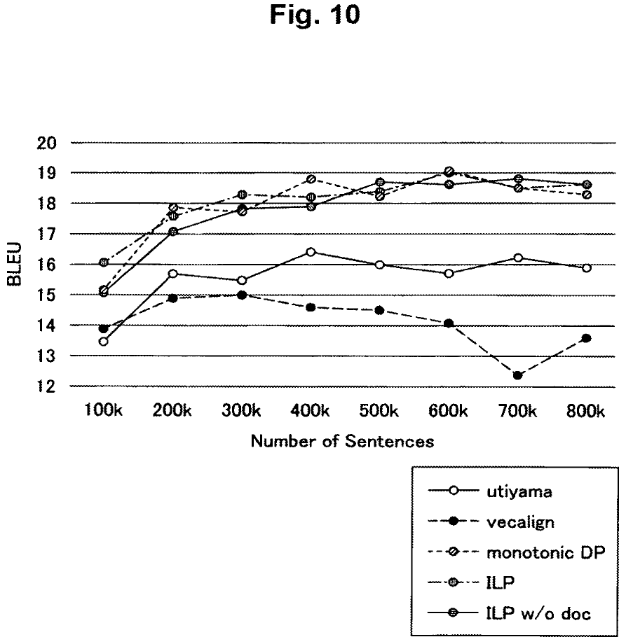

Next, Experiment 2 will be described. Parallel translation sentence data extracted by sentence alignment is essential for training of a cross-language model mainly using a machine translation system. Accordingly, in order to evaluate effectiveness in the downstream task of Example 1, an accuracy comparison experiment in a Japanese to English machine translation model was conducted using parallel translation sentences automatically extracted from actual newspaper article data. In this experiment, the following five methods were compared. Parentheses represent a notation in a legend in FIG. 10.
Cross-language span prediction+ILP (ILP w/o doc)
Cross-language span prediction+ILP+document alignment cost (ILP)
Cross-language span prediction+DP (monotonic DP)
Method of Thompson et al. [6] (vecalign)
Method of Utiyama et al. [3] (utiyama)

In Experiment 2, finetuned parallel translation sentence data obtained by extracting a pre-trained machine translation model by the JParaCrawl corpus [10] was evaluated. BLEU [11], which is generally used in machine translation, was used as an evaluation scale.

### Experiment 2: Experiment Data

As in Experiment 1, data was created from The Daily Yomiuri and The Japan News. As the learning data set, articles other than those used in development and evaluation among articles published from 1989 to 2015 were used. For automatic document alignment, the method [3] by Utiyama et al. was used to create 110,821 parallel translation document pairs. Parallel translation sentences were extracted from the parallel translation documents by each method, and used in descending order of quality according to cost and score. As a data set for development and evaluation, similar data to those in Experiment 1 was used, and 15 articles and 168 parallel translations were used as development data, and 15 articles and 238 parallel translations were used as evaluation data.

### Experiment 2: Experiment Results

FIG. 10 illustrates a comparison result of translation accuracy when the amount of parallel translation sentence pairs used for training is changed. It can be seen that the result of the sentence alignment method by the cross-language span prediction achieves higher accuracy than the baseline. In particular, the method using ILP and document alignment costs achieved a BLEU score of at most 19.0 pt, which is 2.6 pt higher than the best baseline result. From these results, it can be seen that the technique of Example 1 effectively works on the automatically extracted parallel translation document and is useful in the downstream task.

Focusing on a portion where the amount of data is small, it can be seen that the method using the document alignment cost achieves the same degree of or higher translation accuracy than the other methods using only ILP or DP. From this, it can be seen that the use of the document alignment cost is useful for improving the reliability of the sentence alignment cost and removing a low quality alignment relationship.

### Summary of Example 1

As described above, in Example 1, a problem of identifying a pair of sentence sets (or sentences) aligned with each other in two documents in the alignment relationship with each other is regarded as a set of problems (cross-language span prediction problems) of independently predicting, as a span, a continuous sentence set of a document in another language aligning with a continuous sentence set of a document in a certain language, and overall optimization is performed on a prediction result thereof by the integer linear programming, thereby achieving highly accurate sentence alignment.

The cross-language span prediction model of Example 1 is created, for example, by finetuning the pre-trained multilingual model created using only each monolingual text for a plurality of languages, using pseudo correct answer data created by an existing method. By using a model in which a structure called self-attention is used as the multilingual model and combining and inputting the source language sentence and the target language document to the model, it is possible to consider context before and after a span and information in units of tokens at the time of prediction. As compared with a conventional method using the bilingual dictionary or the vector representation of a sentence, it is possible to predict a sentence alignment relationship possibility with high accuracy.

Note that the cost of creating the correct answer data is very high. On the other hand, a sentence alignment task requires more correct answer data than a word alignment task described in Example 2. Accordingly, in Example 1, a good result is obtained by using the pseudo correct answer data as the correct answer data. When the pseudo correct answer data can be used, supervised learning can be performed, so that a high-performance model can be trained as compared with an unsupervised model.

In addition, the integer linear programming used in Example 1 does not assume monotonicity of the alignment relationship. Thus, it is possible to obtain a sentence alignment with very high accuracy as compared with the conventional method assuming monotonicity. At that time, by using a score obtained by symmetrizing scores in two directions obtained from asymmetric cross-language span prediction, reliability of a prediction possibility is improved, which contributes to further accuracy improvement.

Techniques for automatically identifying the sentence alignment receiving two documents in an alignment relationship with each other as inputs have various influences related to natural language processing techniques. For example, as in Experiment 2, by mapping a sentence in a document in a certain language (for example, Japanese) to a sentence having a parallel translation relationship in a document translated into another language on the basis of the sentence alignment, learning data of the machine translator between the languages can be generated. Alternatively, by extracting a pair of sentences having the same meaning on the basis of the sentence alignment from a document and a document obtained by rewriting the document in plain expression in the same language, learning data of a rephrased sentence generator or a vocabulary simplifier can be obtained.

### REFERENCE DOCUMENTS OF EXAMPLE 1

[1] William A. Gale and Kenneth W. Church. A program for aligning sentences in bilingual corpora. Computational Linguistics, Vol. 19, No. 1, pp. 75-102, 1993.
[2] Takehito Utsuro, Hiroshi Ikeda, Masaya Yamane, Yuji Matsumoto, and Makoto Nagao. Bilingual text, matching using bilingual dictionary and statistics. In Proceedings of the COLING-1994, 1994.
[3] Masao Utiyama and Hitoshi Isahara. Reliable measures for aligning japanese-english news articles and sentences. In Proceedings of the ACL-2003, pp. 72-79, 2003.
[4] D. Varga, L. Nemeth, P. Halacsy, A. Kornai, V. Tron, and V. Nagy. Parallel corpora for medium density languages. In Proceedings of the RANLP-2005, pp. 590-596, 2005.
[5] Rico Sennrich and Martin Volk. Iterative, MT-based sentence alignment of parallel texts. In Proceedings of the 18th Nordic Conference of Computational Linguistics (NODALIDA 2011), pp. 175-182, Riga, Latvia, May 2011. Northern European Association for Language Technology (NEALT).
[6] Brian Thompson and Philipp Koehn. Vecalign: Improved sentence alignment in linear time and space. In Proceedings of EMNLP-2019, pp. 1342-1348, 2019.
[7] S. E. Robertson and S. Walker. Some simple effective approximations to the 2-poisson model for probabilistic weighted retrieval. In Proceedings of the SIGIR-1994, pp. 232-241, 1994.
[8] Pranav Rajpurkar, Jian Zhang, Konstantin Lopyrev, and Percy Liang. Squad: 100,000+ questions for machine comprehension of text. In Proceedings of EMNLP-2016, pp. 2383-2392, 2016.
[9] Jacob Devlin, Ming-Wei Chang, Kenton Lee, and Kristina Toutanova. Bert: Pre-training of deep bidirectional transformers for language understanding. In Proceedings of the NAACL-2019, pp. 4171-4186, 2019.
[10] Makoto Morishita, Jun Suzuki, and Masaaki Nagata. JParaCrawl: A large scale web-based English-Japanese parallel corpus. In Proceedings of The 12th Language Resources and Evaluation Conference, pp. 3603-3609, Marseille, France, May 2020. European Language Resources Association.
[11] Kishore Papineni, Salim Roukos, Todd Ward, and Wei-Jing Zhu. Bleu: a method for automatic evaluation of machine translation. In Proceedings of the 40th Annual Meeting of the Association for Computational Linguistics, pp. 311-318, Philadelphia, Pennsylvania, USA, July 2002. Association for Computational Linguistics.

### Example 2

Next, Example 2 will be described. In Example 2, a technique for identifying a word alignment between two sentences translated from each other will be described. Identifying a word or a set of words translated from each other in two sentences translated from each other is referred to as word alignment.

Techniques for automatically identifying the word alignment using two sentences translated from each other as inputs include various applications related to multilingual processing and machine translation. For example, by mapping an annotation related to a unique expression such as a name, a place name, or an organization name given in a sentence of a certain language (for example, English) to a sentence translated into another language (for example, Japanese) on the basis of the word alignment, learning data of a unique expression extractor of the language can be generated.

In Example 2, a problem of requesting word alignment in two sentences translated from each other is regarded as a set of problems (cross-language span prediction) of predicting a word or a continuous word string (span) of the sentence of the another language aligning with each word of the sentence of the certain language, and the cross-language span prediction model is trained using the neural network from a small number of pieces of correct answer data created manually, thereby achieving highly accurate word alignment. Specifically, the word alignment device 300 to be described later executes processing related to the word alignment.

Note that, in addition to the generation of the learning data of the unique expression extractor described above, there is, for example, the following application for word alignment.

When a web page in a certain language (for example, Japanese) is translated into another language (for example, English), by identifying a range of a character string of a sentence in the another language semantically equivalent to the range of a character string surrounded by an HTML tag (for example, anchor tag <a> . . . </a>) in a sentence in the original language on the basis of the word alignment, the HTML tag can be correctly mapped.

Further, in the machine translation, when a specific translation word is desired to be specified for a specific word or phrase of an input sentence in the bilingual dictionary or the like, a word or phrase of an output sentence aligning with the word or phrase of the input sentence is obtained on the basis of the word alignment, and when the word or phrase is not the specified word or phrase, the translation word can be controlled by substituting the word or phrase with the specified word or phrase.

Hereinafter, first, in order to facilitate understanding of the technique according to Example 2, various reference techniques related to the word alignment will be described. Thereafter, a configuration and operation of the word alignment device 300 according to Example 2 will be described.

Note that the numbers and document names of reference documents related to the reference technique and the like of Example 2 are collectively described at the end of Example 2. In the following description, numbers of related reference documents are indicated as “[1]” or the like.

### Example 2: Description of Reference Technique

<Unsupervised Word Alignment Based on Statistical Machine Translation Model>

As a reference technique, first, unsupervised word alignment based on a statistical machine translation model will be described.

In the statistical machine translation [1], a translation model P(E|F) for converting a sentence F in a source language (translation source language, source language) into a sentence E in a target language (translation destination language, target language) is decomposed into a product of a reverse translation model P(F|E) and a language model P(E) for generating a word string in the target language using Bayes' theorem.

$$[ Math . 10 ]$$

$$\hat{E} = arg {max}_{E} P ( E \vert F ) = arg {max}_{E} P ( E ) P ( F \vert E ) \qquad ( 10 )$$

In the statistical machine translation, it is assumed that the translation probability is determined depending on the word alignment A between the word of the sentence F of the source language and the word of the sentence E of the target language, and the translation model is defined as the sum of all possible word alignments.

$$[ Math . 11 ]$$

$$P ( F \vert E ) = {\sum }_{A} P ( F , A \vert E ) \qquad ( 11 )$$

Note that, in the statistical machine translation, the source language F and the target language E in which the translation is actually performed are different from the source language E and the target language F in the reverse translation model P(F|E). Since this causes confusion, an input X and an output Y of the translation model P(Y|X) are hereinafter referred to as a source language and a target language, respectively.

When the source language sentence X is a word string x_{1:|X|}=x₁, x₂, . . . , x_{|X|} having a length |X|, and the target language sentence Y is a word string y_{1:|Y|}=y₁, y₂, . . . , y_{|Y|} having a length |Y|, the word alignment A from the target language to the source language is defined as a_{1:|Y|}=a₁, a₂, . . . , a_{|Y|}. Here, aⱼ represents that a word yⱼ of the target language sentence aligns with a word xₐⱼ of the target language sentence.

In the generative word alignment, a translation probability based on a certain word alignment A is decomposed into a product of a vocabulary translation probability Pₜ(yⱼ| . . . ) and a word alignment probability Pₐ(aⱼ| . . . ).

$$[ Math . 12 ]$$

$$P ( Y , A \vert X ) {\prod }_{j = 1}^{J} {P}_{t} ( {y}_{j} \vert {a}_{j} , {y}_{< j} , X ) {P}_{a} ( {a}_{j} \vert {a}_{< j} , {y}_{< j} , X ) \qquad ( 12 )$$

For example, in a model 2 described in reference document [1], first, the length |Y| of the target language sentence is determined, and it is assumed that the probability Pₐ(aⱼ|j, . . . ) that the j-th word of the target sentence aligns with the aⱼ-th word of the source language sentence depends on the length |Y| of the target language sentence and the length |X| of the source language sentence.

$$[ Math . 13 ]$$

$$P ( Y , A \vert X ) = {\prod }_{j = 1}^{\vert Y \vert} {P}_{t} ( {y}_{j} \vert {x}_{{a}_{j}} ) {P}_{a} ( {a}_{j} \vert j , \vert Y \vert , \vert X \vert ) \qquad ( 13 )$$

As models described in reference document [1], there are five models that become complicated in order from the simplest model 1 to the most complicated model 5. The model 4, which is often used in word alignment, considers fertility representing how many words in one language align with one word in another language, and distortion representing the distance between an alignment destination of the immediately preceding word and an alignment destination of the current word.

In addition, in the word alignment [25] based on the HMM, it is assumed that the word alignment probability depends on the word alignment of the immediately preceding word in the target language sentence.

$$[ Math . 14 ]$$

$$P ( T , A \vert X ) = {\prod }_{j = 1}^{\vert Y \vert} {P}_{t} ( {y}_{j} \vert {x}_{{a}_{j}} ) {P}_{a} ( {a}_{j} \vert {a}_{j - 1} , \vert X \vert ) \qquad ( 14 )$$

In these statistical machine translation models, the word alignment probability is trained using EM algorithm from a set of parallel translation sentence pairs to which the word alignment is not given. That is, the word alignment model is trained by unsupervised learning.

Unsupervised word alignment tools based on the models described in reference document [1] include GIZA++ [16], MGIZA [8], FastAlign [6], and the like. GIZA++ and MGIZA are based on the model 4 described in reference document [1] and FastAlign is based on the model 2 described in reference document [1].

<Word Alignment Based on Recurrent Neural Network>

Next, word alignment based on a recurrent neural network will be described. Methods of unsupervised word alignment based on the neural network include a method of applying the neural network to word alignment based on an HMM [26, 21] and a method based on attention in neural machine translation [27, 9].

Regarding the method of applying the neural network to the word alignment based on the HMM, for example, Tamura et al. [21] propose a method of determining the alignment destination of the current word in consideration of not only the immediately preceding word alignment but also a history a<ⱼ=a_{1:j-1} of the word alignment from the beginning of the sentence by using a recurrent neural network (RNN), and obtaining the word alignment as one model instead of separately modeling the vocabulary translation probability and the word alignment probability.

$$[ Math . 15 ]$$

$$P ( A \vert X , Y ) = {\prod }_{j = 1}^{\vert Y \vert} {P}_{RNN} ( {a}_{j} \vert {a}_{< j} , {y}_{j} , {x}_{{a}_{j}} ) \qquad ( 15 )$$

The word alignment based on the recurrent neural network requires a large amount of teacher data (parallel translation sentence to which the word alignment is given) to train the word alignment model. However, in general, a large amount of manually created word alignment data does not exist. In a case where a parallel translation sentence to which the word alignment is automatically given using unsupervised word alignment software GIZA++ is used as learning data, the word alignment based on the recurrent neural network is reported to have accuracy equal to or slightly higher than that of GIZA++.

<Unsupervised Word Alignment Based on Neural Machine Translation Model>

Next, unsupervised word alignment based on a neural machine translation model will be described. The neural machine translation achieves conversion from the source language sentence to the target language sentence on the basis of an encoder-decoder model.

An encoder (encoder) converts a source language sentence X=x_{i:|x|}=x₁, . . . , x_{|X|} having a length |X| into a sequence s_{1:|X|}=s₁, . . . , s_{|X|}, of an internal state having a length |X| by a function enc representing nonlinear conversion using the neural network. Assuming that the number of dimensions of the internal state aligning with each word is d, s_{1:|X|} is a matrix of |×|×d.

[Math. 16]

s_{1:|X|}=enc(x_{1:|X|}) (16)

The decoder (decoder) receives the output s_{1:|X|} of the encoder as an input, and generates the j-th word yⱼ of the target language sentence one by one from the beginning of the sentence by a function dec representing nonlinear conversion using the neural network.

[Math. 17]

[symbol]

ⱼ=dec(h_{1:|X|}^{src}, [symbol] <j) (17)

Here, when the decoder generates the target language sentence Y=y_{1:|Y|}=y₁, . . . , y_{|Y|} having the length |Y|, the sequence of the internal state of the decoder is expressed as t_{1:|Y|}=t₁, . . . , t_{|Y|}. Assuming that the number of dimensions of the internal state aligning with each word is d, t_{1:|Y|} is a matrix of |Y|×d.

In the neural machine translation, translation accuracy is greatly improved by introducing an attention mechanism. The attention mechanism is a mechanism that determines which word information of the source language sentence is used by changing the weight for the internal state of the encoder when the decoder generates each word of the target language sentence. A basic idea of the unsupervised word alignment based on the attention of the neural machine translation is to consider a value of this attention as a probability that two words are mutually translated.

As an example, the attention between the source language sentence and the target language sentence (source-target attention, source language-target language attention) in Transformer [23], which is a representative neural machine translation model, will be described. Transformer is an encoder-decoder model in which an encoder and a decoder are parallelized by combining self-attention and a feedforward neural network. The attention between the source language sentence and the target language sentence in Transformer is called cross attention in order to distinguish the attention from the self-attention.

Transformer uses scaled dot-product attention as attention. The scaled dot-product attention is defined for the query Q∈R^{lq×dk}, the key K∈R^{lk×dk}, and the value V E R^{lk×dv} as the following expression.

$$[ Math . 18 ]$$

$$Attention ( Q , K , V ) = softmax ( \frac{{QK}^{T}}{\sqrt{{d}_{k}}} ) V \qquad ( 18 )$$

Here, l_{q} is the length of the query, lₖ is the length of the key, dₖ is the number of dimensions of the query and the key, and dᵥ is the number of dimensions of the value.

In the cross attention, Q, K, and V are defined as follows with W_{Q}∈R^{d×dk}, W_{K}∈R^{d×dk}, and W_{V}∈R^{d×dv} as weights.

[Math. 19]

Q=[tⱼ]^{T}W_{Q} (19)

[Math. 20]

K=[s_{1:|X|}]^{T}W_{K} (20)

[Math. 21]

V=[S_{1:|x|}]^{T}W_{V} (21)

Here, tⱼ is an internal state when the decoder generates the word of the j-th target language sentence. Further, [ ]^{T} represents a transposed matrix.

At this time, a weighting matrix A_{|Y|+|X|} of cross attention between the source language sentence and the target language sentence is defined as Q=[t_{1:|Y|}]^{T}W_{Q}.

$$[ Math . 22 ]$$

$$Q = {T}_{1}^{I} {W}_{Q} \qquad ( 22 )$$

$$[ Math . 23 ]$$

$${A}_{\vert Y \vert \times \vert X \vert} = softmax ( \frac{{QK}^{T}}{\sqrt{d}} ) \qquad ( 23 )$$

This represents a ratio of contribution of a word xᵢ of the source language sentence to generation of the j-th word yⱼ of the target language sentence, and thus can be regarded as representing a distribution of probabilities that the word xᵢ of the source language sentence aligns with each word yⱼ of the target language sentence.

In general, Transformer uses a plurality of layers and a plurality of heads (head, attention mechanism trained from different initial values), but here, the number of layers and heads is set to one in order to simplify the description.

Garg et al. have reported that the average of cross attentions of all heads in the second layer from the top is closest to the correct answer of the word alignment and, by using a word alignment distribution GP obtained in this manner, defined a cross entropy loss as follows for the word alignment obtained from a specific head among the plurality of heads,

$$[ Math . 24 ]$$

$${L}_{α} ( A ) = - \frac{1}{\vert Y \vert} {\sum }_{j = 1}^{\vert Y \vert} {\sum }_{i = 1}^{\vert X \vert} {G}_{j , i}^{p} log ( {A}_{j , i} ) \qquad ( 24 )$$

and proposed multi-task learning that minimizes a weighted linear sum of loss of the word alignment and loss of the machine translation [9]. Expression (15) represents that the word alignment is regarded as a problem of multi-level classification that determines which word in the source language sentence aligns with a word in the target language sentence.

The method of Garg et al. uses the entire target language sentence t_{1:|Y|} instead of t_{1:i-1} from the beginning of the sentence to immediately before the j-th word in Expression (10) when calculating the loss of the word alignment. Furthermore, as teacher data G^{p} of the word alignment, the word alignment obtained from GIZA++ is used instead of self-training based on Transformer. Thus, it has been reported that the word alignment accuracy exceeding GIZA++ can be obtained [9].

<Supervised Word Alignment Based on Neural Machine Translation Model>

Next, supervised word alignment based on the neural machine translation model will be described. For the source language sentence X=x_{1:|X|} and the target language sentence Y=y_{1:|Y|}, a subset of a Cartesian product set of word positions is defined as word alignment A.

[Math. 25]

[symbol]

⊆{(i,j):i=1, . . . ,|X|;j=1 . . . ,|Y|} (25)

The word alignment can be considered as a many-to-many discrete mapping from the word of the source language sentence to the word of the target language sentence.

In discriminative word alignment, word alignment is directly modeled from the source language sentence and the target language sentence.

[Math. 26]

P(aᵢⱼ|X,Y) (26)

For example, Stengel-Eskin et al. proposed a method for discriminately obtaining a word alignment using an internal state of neural machine translation [20]. In the method of Stengel-Eskin et al., first, when a sequence of internal states of an encoder in a neural machine translation model is s₁, . . . , s_{|X|}, and a sequence of internal states of a decoder is t₁, . . . , t_{|Y|}, they are projected to a common vector space using a three-layer forward propagation neural network sharing parameters.

[Math. 27]

s′ᵢ=W₃(tanh(W₂(tanh(W₁sᵢ)))) (27)

[Math. 28]

t′ⱼ=W₃(tanh(W₂(tanh(W₁tⱼ)))) (28)

A matrix product of a word sequence of the source language sentence and a word sequence of the target language projected to the common space is used as an unnormalized distance scale of s′ᵢ and t′ⱼ.

[Math. 29]

A=[s′_{1:|X|}]·[t′_{1:|Y|}]^{T} (29)

Furthermore, the convolution operation is performed using the 3×3 kernel W_{conv} so that the word alignment depends on the context of the preceding and following words, to thereby obtain aᵢⱼ.

[Math. 30]

A′=W_{conv}*A (30)

A binary cross entropy loss is used as an independent binary classification problem for determining whether or not each pair aligns for all combinations of the word of the source language sentence and the word of the target language sentence.

$$[ Math . 31 ]$$

$${\sum }_{i = 1}^{\vert Y \vert} {{\sum }^{\vert X \vert}}_{j = 1} ( {\hat{a}}_{ij} log ( P ( {a}_{ij} \vert X , Y ) ) + ( 1 - {\hat{a}}_{ij} ) log ( 1 - P ( {a}_{ij} \vert X , Y ) ) ) \qquad ( 31 )$$

Here, \hat{ }aᵢⱼ represents whether or not the word xᵢ of the source language sentence and the word yⱼ of the target language sentence align with each other in the correct answer data. Note that, in the text of the present description, a hat “\hat{ }” to be placed on the head of a character is described before the character for convenience.

$$[ Math . 32 ]$$

$${\hat{a}}_{ij} = \{ \begin{matrix}1 , {x}_{i} and {y}_{j} align in correct answer data \\ 0 , {x}_{i} and {y}_{ji} do not align in correct answer data\end{matrix} \qquad ( 32 )$$

Stengel-Eskin et al. have reported that by pre-training a translation model using parallel translation data of about one million sentences and then using correct answer data (1,700 sentences to 5,000 sentences) of word alignments created manually, accuracy significantly exceeding FastAlign was achieved.

<Pre-Trained Model BERT>

For the word alignment, similarly to the sentence alignment in Example 1, the pre-trained model BERT is used, which is as described in Example 1.

### Example 2: Problem

In the word alignment based on the conventional recurrent neural network and the unsupervised word alignment based on the neural machine translation model described as the reference techniques, only accuracy equal to or slightly higher than that of the unsupervised word alignment based on the statistical machine translation model can be achieved.

The supervised word alignment based on a conventional neural machine translation model is more accurate than the unsupervised word alignment based on the statistical machine translation model. However, both the method based on the statistical machine translation model and the method based on the neural machine translation model have a problem that a large amount (about several million sentences) of parallel translation data is required for training the translation model.

Hereinafter, the technique according to Example 2 that has solved the above problems will be described.

(Outline of Technique According To Example 2) In Example 2, the word alignment is achieved as a process of calculating an answer from the problem of cross-language span prediction. First, the cross-language span prediction model is trained by finetuning the pre-trained multilingual model trained from each piece of monolingual data related to a language pair to which at least the word alignment is to be given using correct answer data of a cross-language span prediction created from a correct answer for a manual word alignment. Next, the processing of the word alignment is executed using the trained cross-language span prediction model.

According to the method as described above, in Example 2, the parallel translation data is not required for pre-training of the model for executing the word alignment, and the word alignment can be achieved with high accuracy from the correct answer data of the word alignment created by a small amount of manual work. Hereinafter, the technique according to Example 2 will be described more specifically.

(Device Configuration Example)

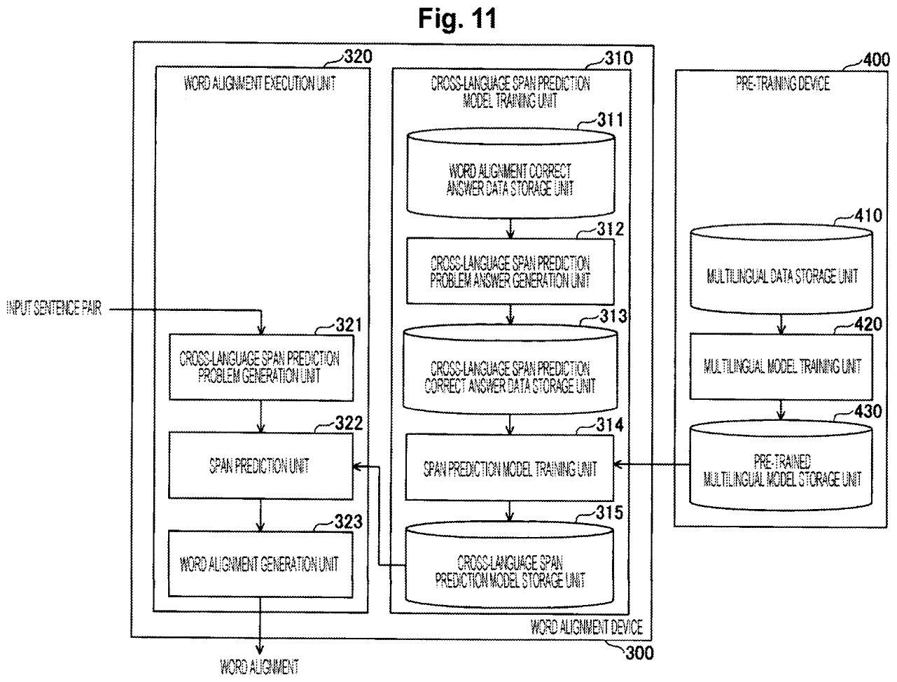

FIG. 11 illustrates a word alignment device 300 and a pre-training device 400 in Example 2. The word alignment device 300 is a device that executes word alignment processing according to the technique according to Example 2. The pre-training device 400 is a device that trains a multilingual model from multilingual data.

As illustrated in FIG. 11, the word alignment device 300 has a cross-language span prediction model training unit 310 and a word alignment execution unit 320.

The cross-language span prediction model training unit 310 has a word alignment correct answer data storage unit 311, a cross-language span prediction problem answer generation unit 312, a cross-language span prediction correct answer data storage unit 313, a span prediction model training unit 314, and a cross-language span prediction model storage unit 315. Note that the cross-language span prediction problem answer generation unit 312 may be referred to as a problem answer generation unit.

The word alignment execution unit 320 has a cross-language span prediction problem generation unit 321, a span prediction unit 322, and a word alignment generation unit 323. Note that the cross-language span prediction problem generation unit 321 may be referred to as a problem generation unit.

The pre-training device 400 is a device according to an existing technique. The pre-training device 400 has a multilingual data storage unit 410, a multilingual model training unit 420, and a pre-trained multilingual model storage unit 430. The multilingual model training unit 420 reads monolingual texts of at least two languages for which the word alignment is to be obtained from the multilingual data storage unit 410 to thereby train a language model, and stores the language model as the pre-trained multilingual model in the pre-trained multilingual model storage unit 230.

Note that, in Example 2, since it is sufficient if the pre-trained multilingual model trained by some means is input to the cross-language span prediction model training unit 310, for example, a general-purpose pre-trained multilingual model disclosed to the public may be used without having the pre-training device 400.

The pre-trained multilingual model in Example 2 is a language model trained in advance using monolingual texts of two languages for which at least the word alignment is to be obtained. In Example 2, Multilingual BERT is used as the language model, but the language model is not limited thereto. Any language model may be used as long as it is a pre-trained multilingual model such as XLM-RoBERTa that can output word embedding vectors in consideration of the context with respect to multilingual text.

Note that the word alignment device 300 may be referred to as a learning device. In addition, the word alignment device 300 may include the word alignment execution unit 320 without including the cross-language span prediction model training unit 310. Further, a device provided with the cross-language span prediction model training unit 310 alone may be referred to as a learning device.

(Outline of Operation of Word Alignment Device 300)

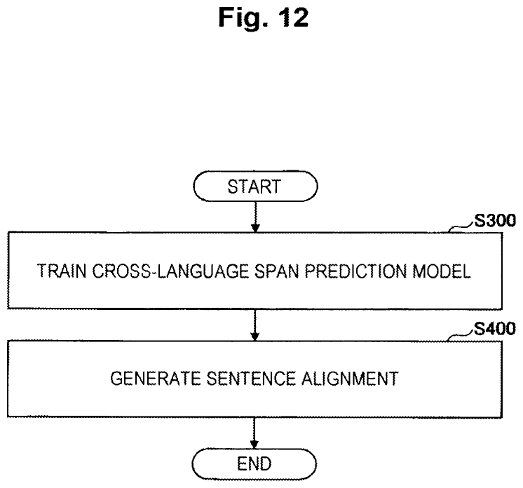

FIG. 12 is a flowchart illustrating an entire operation of the word alignment device 300. In S300, the pre-trained multilingual model is input to the cross-language span prediction model training unit 310, and the cross-language span prediction model training unit 310 trains the cross-language span prediction model on the basis of the pre-trained multilingual model.

In S400, the cross-language span prediction model trained in S300 is input to the word alignment execution unit 320, and the word alignment execution unit 320 generates and outputs the word alignment in an input sentence pair (two sentences that are mutually translated) using the cross-language span prediction model.

<S300>

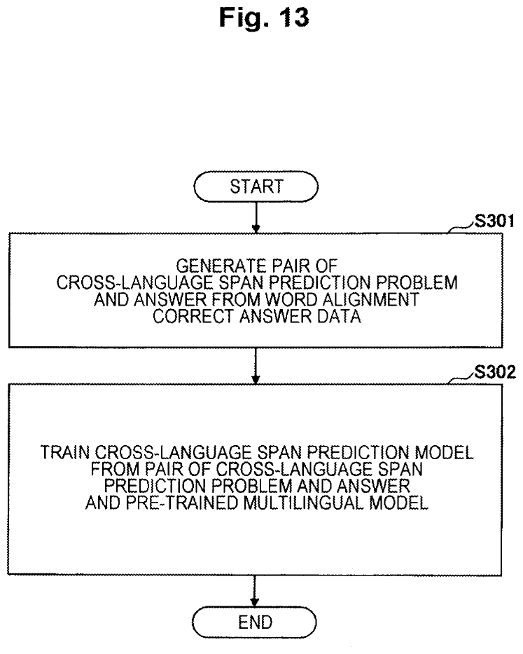

With reference to a flowchart of FIG. 13, content of processing of training the cross-language span prediction model in the above-described S300 will be described. Here, it is assumed that the pre-trained multilingual model has already been input and the pre-trained multilingual model is stored in a storage device of the span prediction model training unit 324. In addition, the word alignment correct answer data storage unit 311 stores word alignment correct answer data.

In S301, the cross-language span prediction problem answer generation unit 312 reads the word alignment correct answer data from the word alignment correct answer data storage unit 311, generates the cross-language span prediction correct answer data from the read word alignment correct answer data, and stores the cross-language span prediction correct answer data in the cross-language span prediction correct answer data storage unit 313. The cross-language span prediction correct answer data is data including a set of pairs of a cross-language span prediction problem (question and context) and an answer thereof.

In S302, the span prediction model training unit 314 trains the cross-language span prediction model from the cross-language span prediction correct answer data and the pre-trained multilingual model, and stores the trained cross-language span prediction model in the cross-language span prediction model storage unit 315.

<S400>

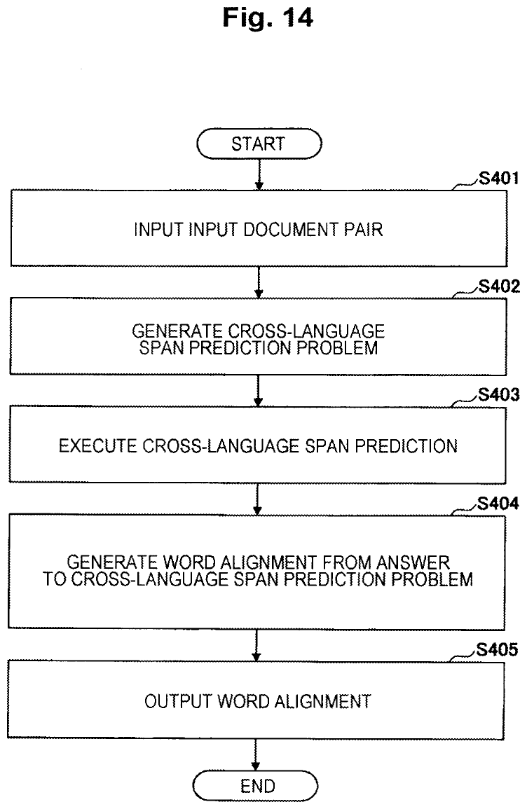

Next, content of processing of generating the word alignment in the above-described S400 will be described with reference to a flowchart of FIG. 14. Here, it is assumed that the cross-language span prediction model has already been input to the span prediction unit 322 and stored in a storage device of the span prediction unit 322.

In S401, a pair of a first language sentence and a second language sentence is input to the cross-language span prediction problem generation unit 321. In S402, the cross-language span prediction problem generation unit 321 generates a cross-language span prediction problem (question and context) from the input pair of sentences.

Next, in S403, the span prediction unit 322 performs the span prediction on the cross-language span prediction problem generated in S402 using the cross-language span prediction model, and obtains an answer.

In S404, the word alignment generation unit 323 generates the word alignment from the answer to the cross-language span prediction problem obtained in S403. In S405, the word alignment generation unit 323 outputs the word alignment generated in S404.

### Example 2: Description of Specific Processing Contents

Hereinafter, content of processing of the word alignment device 300 in Example 2 will be described more specifically.

<Formulation from Word Alignment to Span Prediction>

As described above, in Example 2, the processing of the word alignment is executed as the processing of the cross-language span prediction problem. Accordingly, first, formulation from the word alignment to the span prediction will be described using an example. In relation to the word alignment device 300, here, the cross-language span prediction model training unit 310 will be mainly described.

—Regarding Word Alignment Data—

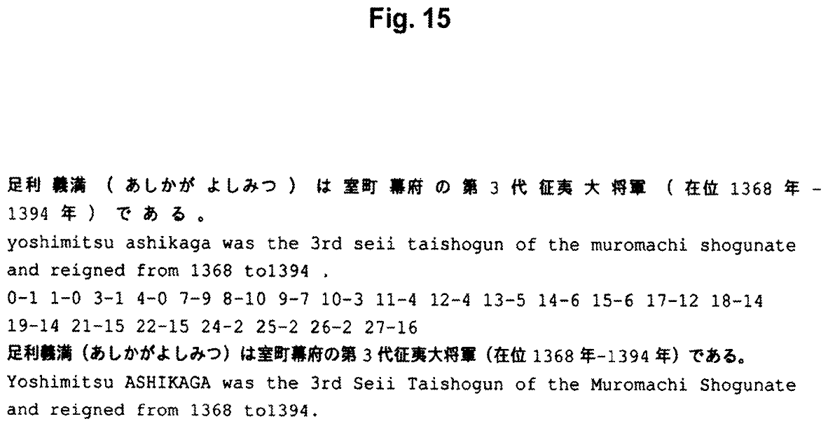

FIG. 15 illustrates an example of word alignment data of Japanese and English. This is an example of one piece of the word alignment data. As illustrated in FIG. 15, one piece of word alignment data includes five pieces of data of a token (word) string of a first language (Japanese), a token string of a second language (English), a string of aligning token pairs, an original sentence of the first language, and an original sentence of the second language.

The token string of the first language (Japanese) and the token string of the second language (English) are both indexed. Starting from 0, which is the index of the first element of the token string (the leftmost token), it is indexed as 1, 2, 3, . . . .

For example, the first element “0-1” of the third data indicates that the first element “ [symbol] ” of the first language aligns with the second element “ashikaga” of the second language. In addition, “24-2 25-2 26-2” indicate that “ [symbol] ”, “ [symbol] ”, and “ [symbol] ” all align with “was”.

In Example 2, the word alignment is formulated as the cross-language span prediction problem similar to the SQuAD format question answering task [18].

The question answering system that performs the question answering task in the SQuAD format is given a “context” and a “question”, such as a paragraph selected from Wikipedia, and the question answering system predicts a “span (partial character string)” in the context as an “answer”.

Similarly to the span prediction described above, the word alignment execution unit 320 in the word response device 300 of Example 2 regards a target language sentence as the context, regards words of the source language sentence as the question, and predicts a word or a word string in the target language sentence, which is a translation of the words of the source language sentence, as the span of the target language sentence. For this prediction, the cross-language span prediction model in Example 2 is used.

—Cross-Language Span Prediction Problem Answer Generation Unit 312—

In Example 2, the supervised learning of the cross-language span prediction model is performed in the cross-language span prediction model training unit 310 of the word alignment device 300, but the correct answer data is necessary for learning.

In Example 2, a plurality of pieces of word alignment data as illustrated in FIG. 15 is stored as the correct answer data in the word alignment correct answer data storage unit 311 of the cross-language span prediction model training unit 310, and is used for training of the cross-language span prediction model.

However, since the cross-language span prediction model is a model that predicts an answer (span) from a cross-language question, data generation for performing training of predicting an answer (span) from the cross-language question is performed. Specifically, by receiving the word alignment data as an input to the cross-language span prediction problem answer generation unit 312, the cross-language span prediction problem answer generation unit 312 generates a pair of a cross-language span prediction problem (question) and an answer (span, partial character string) in the SQuAD format from the word alignment data. Hereinafter, an example of processing of the cross-language span prediction problem answer generation unit 312 will be described.

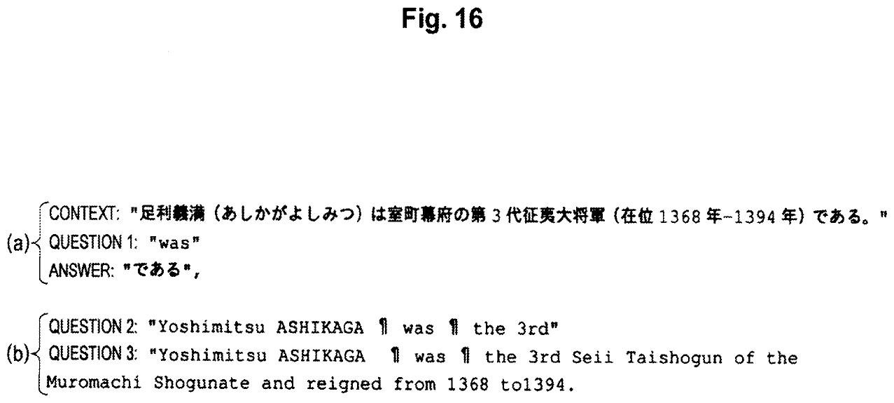

FIG. 16 illustrates an example of converting the word alignment data illustrated in FIG. 15 into a span prediction problem in the SQuAD format.

First, an upper half illustrated in (a) of FIG. 16 will be described. The upper half (context, question 1, and answer portion) in FIG. 16 illustrates that a sentence in the first language (Japanese) of the word alignment data is given as a context, a token “was” in the second language (English) is given as a question 1, and an answer thereof is a span “ [symbol] ” of the sentence in the first language. The alignment between “ [symbol] ” and “was” corresponds to aligning token pairs “24-2 25-2 26-2” of the third data in FIG. 15. That is, the cross-language span prediction problem answer generation unit 312 generates a pair of a span prediction problem (question and context) and an answer in the SQuAD format on the basis of the aligning token pair of the correct answer.

As will be described later, in Example 2, the span prediction unit 322 of the word alignment execution unit 320 performs prediction for each direction of prediction from the first language sentence (question) to the second language sentence (answer) and prediction from the second language sentence (question) to the first language sentence (answer) using the cross-language span prediction model. Therefore, also at the time of training of the cross-language span prediction model, training is performed so as to perform bidirectional prediction in this manner.

Note that performing bidirectional prediction as described above is an example. The prediction in one direction of only prediction from the first language sentence (question) to the second language sentence (answer) or only prediction from the second language sentence (question) to the first language sentence (answer) may be performed. For example, in English education or the like, in a case where an English sentence and a Japanese sentence are displayed at the same time, an arbitrary character string (word string) of the English sentence is selected with a mouse or the like, and a character string (word string) of the Japanese sentence as a parallel translation thereof is calculated and displayed on the spot, prediction only in one direction may be used.

Thus, the cross-language span prediction problem answer generation unit 312 of Example 2 converts one piece of word alignment data into a set of questions for predicting the span in the sentence of the second language from each token of the first language and a set of questions for predicting the span in the sentence of the first language from each token of the second language. That is, the cross-language span prediction problem answer generation unit 312 converts one piece of word alignment data into a set of questions and respective answers (spans in the sentence of the second language) including respective tokens of the first language, and a set of questions and respective answers (spans in the sentence of the first language) including respective tokens of the second language.

If one token (question) aligns with a plurality of spans (answers), the question is defined as having a plurality of answers. That is, the cross-language span prediction problem answer generation unit 112 generates a plurality of answers to the question. In addition, if there is no span aligning with a certain token, the question is defined as having no answer. That is, the cross-language span prediction problem answer generation unit 312 assumes that there is no answer to the question.

In Example 2, the language of the question is referred to as a source language, and the language of the context and the answer (span) is referred to as a target language. In the example illustrated in FIG. 16, the source language is English and the target language is Japanese, and this question is referred to as an “English-to-Japanese” question.

If the question is a word with a high frequency such as “of”, there is a possibility that the word appears in the source language sentence a plurality of times, and thus it is difficult to find the aligning span of the target language sentence without considering the context of the word in the source language sentence. Accordingly, the cross-language span prediction problem answer generation unit 312 of Example 2 generates a question with context.

An example of a question with context of the source language sentence is illustrated in a lower half portion illustrated in (b) of FIG. 16. In a question 2, the immediately preceding two tokens “Yoshimitsu ASHIKAGA” and the immediately following two tokens “the 3rd” in the context are added with “ [symbol] ” as boundary markers to the token “was” of the source language sentence that is the question.

Further, in a question 3, the entire source language sentence is used as the context, and a token serving as a question is sandwiched between two boundary markers. As will be described later in the experiment, the context added to the question is longer the better, and thus, in Example 2, the entire source language sentence is used as the context of the question as in the question 3.

As described above, in Example 2, the paragraph mark ‘ [symbol] ’ is used as a boundary marker. This symbol is called pilcrow in English. The pilcrow belongs to punctuation of the Unicode character category, is included in the vocabulary of the multilingual BERT and hardly appears in a normal text, and thus is used as a boundary marker that separates the question from the context in Example 2. Any boundary marker may be used as long as the character or character string satisfies a similar nature.

In addition, the word alignment data includes many null alignments (meaning that there is no alignment destination). Accordingly, in Example 2, the formulation of SQuAD v2.0 [17] is used. The difference between SQuAD v1.1 and SQuAD v2.0 is to explicitly address the possibility that an answer to a question does not exist in the context.

That is, in the format of SQuAD v2.0, since it is explicitly indicated that a question that cannot be answered cannot be answered, a question and an answer (that cannot be answered) can be appropriately generated for a null alignment (meaning that there is no alignment destination) in the word alignment data.

Since tokenization including word division and casing are handled differently depending on the word alignment data, the token string of the source language sentence is used only for the purpose of creating a question in Example 2.

Then, when the cross-language span prediction problem answer generation unit 312 converts the word alignment data into the SQuAD format, the original sentence is used for the question and the context instead of the token string. That is, the cross-language span prediction problem answer generation unit 312 generates, as an answer, a start position and an end position of a span together with a word or a word string of the span from the target language sentence (context), and the start position and the end position are indexes to character positions of the original sentence of the target language sentence.

Note that the word alignment method in the conventional technique often receives a token string as an input. That is, in the example of the word alignment data of FIG. 15, the first two pieces of data are often inputs. On the other hand, in Example 2, by receiving both the original sentence and the token string as inputs to the cross-language span prediction problem answer generation unit 312, the system can flexibly cope with any tokenization.

Data of pairs of the cross-language span prediction problem (question and context) and the answer generated by the cross-language span prediction problem answer generation unit 312 is stored in the cross-language span prediction correct answer data storage unit 313.

—Span Prediction Model Training Unit 314—

The span prediction model training unit 314 trains the cross-language span prediction model using the correct answer data read from the cross-language span prediction correct answer data storage unit 313. That is, the span prediction model training unit 314 inputs the cross-language span prediction problem (question and context) to the cross-language span prediction model, and adjusts the parameters of the cross-language span prediction model so that the output of the cross-language span prediction model becomes a correct answer. This training is performed by each of cross-language span prediction from the first language sentence to the second language sentence and cross-language span prediction from the second language sentence to the first language sentence.

The trained cross-language span prediction model is stored in the cross-language span prediction model storage unit 315. In addition, the word alignment execution unit 320 reads the cross-language span prediction model from the cross-language span prediction model storage unit 315, and inputs the cross-language span prediction model to the span prediction unit 322.

Details of the cross-language span prediction model will be described below. In addition, details of the processing of the word alignment execution unit 320 will be described below.

<Cross-Language Span Prediction Using Multilingual BERT>

As described above, the span prediction unit 322 of the word alignment execution unit 320 in Example 2 generates the word alignment from a pair of input sentences by using the cross-language span prediction model trained by the cross-language span prediction model training unit 310. That is, the word alignment is generated by performing the cross-language span prediction on the input sentence pair.

—Cross-Language Span Prediction Model—

In Example 2, a task of cross-language span prediction is defined as follows.

It is assumed that there are a source language sentence X=x₁x₂ . . . x_{|X|} of a length |X| and a target language sentence Y=y₁y₂ . . . y_{|Y|} of a length |Y|. For a source language token x_{i:j}=xᵢ . . . xⱼ from a character position i to a character position j in the source language sentence, extracting a target language span y_{k:l}=yₖ . . . yₗ from a character position k to a character position l in the target language sentence is the task of the cross-language span prediction.

The span prediction unit 322 of the word alignment execution unit 320 executes the above-described task using the cross-language span prediction model trained by the cross-language span prediction model training unit 310. Also in Example 2, the multilingual BERT [5] is used as the cross-language span prediction model.

BERT also works very well for the cross-language task in example 2. Note that the language model used in Example 2 is not limited to BERT.

More specifically, in Example 2, as an example, a model similar to a model for SQuAD v2.0 task disclosed in the document [5] is used as the cross-language span prediction model. These models (model for SQuAD v2.0 task and cross-language span prediction model) are pre-trained BERT plus two independent output layers that predict a start position and an end position in a context.

In the cross-language span prediction model, probabilities that respective positions in the target language sentence will be the start position and the end position of the answer span are defined as pₛₜₐᵣₜ and p_{end}, a score ω^{X→Y}ᵢⱼₖₗ of the target language span y_{k:l} when a source language span x_{i:j} is given is defined as a product of a probability of the start position and a probability of the end position, and (\hat{ }k, \hat{ }l) that maximizes this product is assumed as a best answer span.

$$[ Math . 33 ]$$

$${ω}_{ijkl}^{X \to Y} = {p}_{start} ( k \vert X , Y , i , j ) \cdot {p}_{end} ( l \vert X , Y , i , j ) \qquad ( 33 )$$

$$[ Math . 34 ]$$

$$( \hat{k} , \hat{l} ) = arg {max}_{( k , 1 ) : 1 \leq k \leq l \leq \vert Y \vert} {ω}_{ijkl}^{X \to Y} \qquad ( 34 )$$

In the SQuAD model of BERT such as the model for the SQuAD v2.0 task and the cross-language span prediction model, first, a sequence “[CLS]question[SEP]context[SEP]” in which a question and a context are connected is set as an input. Here, [CLS] and [SEP] are referred to as a classification token and a separator token, respectively. Then, the start position and the end position are predicted as indexes for this sequence. In the SQuAD v2.0 model assuming no answer, if no answer is present, the start position and the end position are indexes to [CLS].

Although the cross-language span prediction model in Example 2 and the model for the SQuAD v2.0 task disclosed in document [5] have basically the same structure as a neural network, the model for the SQuAD v2.0 task uses a monolingual pre-trained language model, and finetunes (additional learning/transfer learning/fine adjustment/finetuning) learning data of a task that predicts a span between the same languages, whereas the cross-language span prediction model of Example 2 uses the pre-trained multilingual model including two languages related to cross-language span prediction, and finetunes on learning data of a task that predicts a span between two languages.

Note that, in the implementation of the SQuAD model of the existing BERT, only the answer character string is output, but the cross-language span prediction model of Example 2 is configured to be able to output the start position and the end position.

Within BERT, that is, within the cross-language span prediction model of Example 2, the input sequence is first tokenized by a tokenizer (for example, WordPiece), and then the CJK characters (Chinese characters) are divided by one character.

In the implementation of the SQuAD model of the existing BERT, the start position and the end position are indexes to tokens inside the BERT, but in the cross-language span prediction model of Example 2, the start position and the end position are used as indexes to character positions. Thus, it is possible to independently handle the token (word) of input text for which word alignment is obtained and the token inside the BERT.

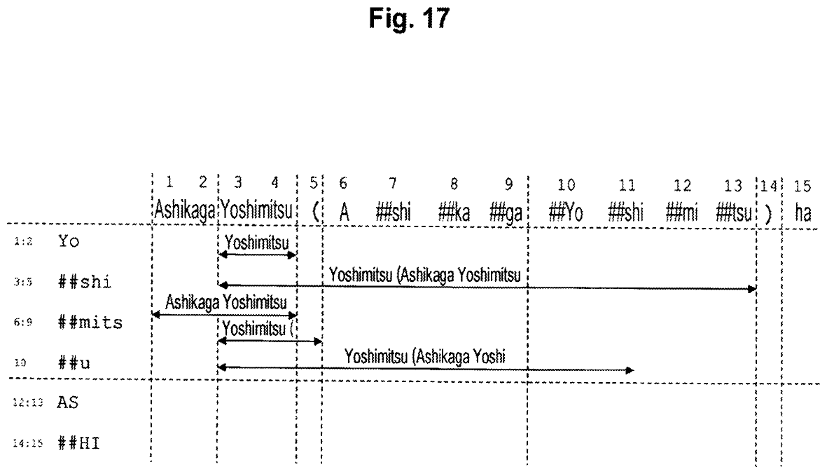

FIG. 17 illustrates processing of predicting the target language (Japanese) span to be an answer from the context of the target language sentence (Japanese) for the token “Yoshimitsu” in the source language sentence (English) to be a question, using the cross-language span prediction model of Example 2. As illustrated in FIG. 17, the “Yoshimitsu” includes four BERT tokens. Note that “##” (prefix) indicating connection with the previous vocabulary is added to the BERT token which is a token inside BERT. Further, the boundary of the input token is indicated by a dotted line. Note that, in the present embodiment, the “input token” and the “BERT token” are distinguished from each other. The former is a unit of word separation in the learning data, and is a unit indicated by a broken line in FIG. 17. The latter is a unit of separation used inside BERT and is a unit separated by a blank in FIG. 17.

In the example illustrated in FIG. 17, five possibilities of “Yoshimitsu”, “Yoshimitsu (Ashikaga Yoshimitsu”, “Ashikaga Yoshimitsu”, “Yoshimitsu (”, and “Yoshimitsu (Ashikaga Yoshi” are indicated as answers, and “Yoshimitsu” is a correct answer.

In BERT, since the span is predicted in units of tokens inside BERT, the predicted span does not necessarily coincide with the boundary of the token (word) of the input. Accordingly, in Example 2, with respect to the target language span that does not coincide with the token boundary of the target language such as “Yoshimitsu (Ashikaga Yoshi”, the process of causing the words of the target language completely included in the predicted target language span, that is, “Yoshimitsu”, “(”, and “Ashikaga” in this example, to align with the source language token (question) is performed. This processing is performed only at the time of prediction, and is performed by the word alignment generation unit 323. At the time of training, training based on a loss function for comparing a first possibility for span prediction with the correct answer with respect to the start position and the end position is performed.

—Cross-language Span Prediction Problem Generation Unit 321 and Span Prediction Unit 322—

The cross-language span prediction problem generation unit 321 creates a span prediction problem in the form of “[CLS]question[SEP]context[SEP]” in which the question and the context are connected for each question (input token (word)) with respect to each of the input first language sentence and second language sentence, and outputs the span-prediction problem to the span prediction unit 122. However, as described above, the question is a question with context in which [symbol] is used as a boundary marker, such as “ ” Yoshimitsu ASHIKAGA [symbol] was [symbol] the 3rd Seii Taishogun of the Muromachi Shogunate and reigned from 1368 to 1394.”

The cross-language span prediction problem generation unit 321 generates a problem of span prediction from the first language sentence (question) to the second language sentence (answer) and a problem of span prediction from the second language sentence (question) to the first language sentence (answer).

The span prediction unit 322 calculates an answer (predicted span) and a probability for each question by inputting each problem (question and context) generated by the cross-language span prediction problem generation unit 121, and outputs the answer (predicted span) and the probability for each question to the word alignment generation unit 323.

Note that the above probability is a product of the probability of the start position and the probability of the end position in the best answer span. The processing of the word alignment generation unit 323 will be described below.

<Symmetrization of Word Alignment>

In the span prediction using the cross-language span prediction model of Example 2, since the target language span is predicted for the source language token, the source language and the target language are asymmetric, similar to the model described in reference document [1]. In Example 2, in order to improve reliability of word alignment based on span prediction, a method of symmetrizing bidirectional prediction is introduced.

First, a conventional example of symmetrizing word alignment will be described as a reference. A method for symmetrizing word alignment based on the model described in reference document [1] was first proposed by document [16]. In a representative statistical translation toolkit Moses [11], heuristics such as an intersection, a union, and grow-diag-final are implemented, and grow-diag-final is the default. The intersection (common set) of two word alignments has a high precision and a low recall. The union (set sum) of two word alignments has a low precision and a high recall. Grow-diag-final is a method for obtaining an intermediate word alignment between the intersection and the union.

—Word Alignment Generation Unit 323—

In Example 2, the word alignment generation unit 323 averages the probability of the best span for each token in two directions, and when the average is equal to or larger than a predetermined threshold, the tokens align with each other. This processing is executed by the word alignment generation unit 323 using the output from the span prediction unit 322 (cross-language span prediction model). Note that, as described with reference to FIG. 17, since the predicted span output as the answer does not necessarily coincide with the word separation, the word alignment generation unit 323 also executes processing of adjusting the predicted span so as to align in units of words in one direction. The symmetrization of the word alignment is specifically as follows.

The span of the start position i and the end position j in a sentence X is x_{i:j}. The span of the start position k and the end position 1 in a sentence Y is y_{k:l}. A probability that the token x_{i:j} predicts the span yₖ:a is represented by ω^{X→Y}ᵢⱼₖₗ, and a probability that the token y_{k:l} predicts the span x_{i:j} is represented by ω^{Y→X}ᵢⱼₖₗ. When the probability of the alignment aᵢⱼₖₗ between the token x_{i:j} and the token y_{k:l} is ωᵢⱼₖₗ, in the present embodiment, ωᵢⱼₖₗ is calculated as an average of the probability ω^{X→Y}_{ij\hat{ }k\hat{ }l} of the best span y_{\hat{ }k:\hat{ }l} predicted from x_{i:j} and the probability ω^{Y→X}_{\hat{ }i\hat{ }jkl} of the best span x_{\hat{ }i:\hat{ }j} predicted from y_{k:l}.

$$[ Math . 35 ]$$

$${ω}_{ijkl} = 1 / 2 ( {I}_{\hat{k} \leq k \leq l \leq \hat{l}} ( {ω}_{ij \hat{k} \hat{l}}^{X \to Y} ) + {I}_{\hat{i} \leq i \leq j \leq \hat{j}} ( {ω}_{\hat{i} \hat{j} kl}^{Y \to X} ) ) \qquad ( 35 )$$

Here, I_{A(x)} is an indicator function. I_{A}(x) is a function that returns x when A is true and returns 0 otherwise. In the present embodiment, when ωᵢⱼₖₗ is equal to or larger than the threshold value, x_{i:j} and y_{k:l} are considered to align with each other. Here, the threshold is set to 0.4. However, 0.4 is an example, and a value other than 0.4 may be used as the threshold.

The method of symmetrization used in Example 2 will be referred to as bidirectional averaging (bidirectional average, bidi-avg). The bidirectional average has an equivalent effect to grow-diag-final in that it is simple to implement and finds a word alignment that is intermediate between the union and the intersection. Note that the use of the average is an example. For example, a weighted average of the probability ω^{X→Y}_{ij\hat{ }k\hat{ }l} and the probability ω^{Y→X}_{\hat{ }i\hat{ }jkl} may be used, or a maximum value thereof may be used.

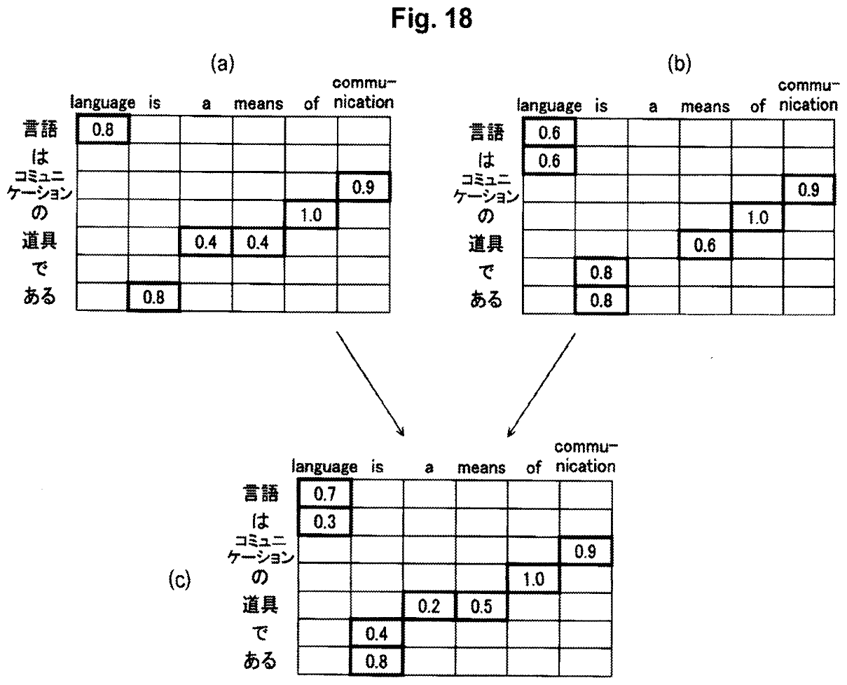

FIG. 18 illustrates symmetrization (c) of a span prediction (a) from Japanese to English and a span prediction (b) from English to Japanese by the bidirectional average.

In the example of FIG. 18, for example, the probability ω^{X→Y}_{ij\hat{ }k\hat{ }l} of the best span “language” predicted from “ [symbol] ” is 0.8, the probability ω^{Y→X}_{\hat{ }i\hat{ }jkl} of the best span “language” predicted from “ [symbol] ” is 0.6, and the average thereof is 0.7. Since 0.7 is equal to or larger than the threshold value, it can be determined that the “ [symbol] [symbol] ” and the “language” align with each other. Thus, the word alignment generation unit 123 generates and outputs a pair of words “ [symbol] ” and “language” as one of results of the word alignment.

In the example of FIG. 18, the pair of words “is” and “ [symbol] ” is predicted only from one direction (English to Japanese), but since the bidirectional average probability is equal to or larger than the threshold, it is considered that the words align with each other.

The threshold value 0.4 is determined by a preliminary experiment in which learning data of word alignment in Japanese and English to be described later is divided into half, using one as training data and the other as test data. This value was used in all experiments described below. Since the span prediction in each direction is performed independently, there is a possibility that it is necessary to normalize the score for symmetrization, but in the experiment, since both directions are trained by one model, the normalization was not necessary.

### Example 2: Effects of Embodiment

With the word alignment device 300 described in Example 2, it is possible to implement supervised word alignment with higher accuracy than before from a smaller amount of teacher data (correct answer data created manually) than before without requiring a large amount of parallel translation data related to a language pair to which word alignment is given.

### Example 2: Experiment

In order to evaluate the technique according to Example 2, an experiment of word alignment was performed, and thus an experimental method and experimental results will be described below.

### Example 2: Experimental Data

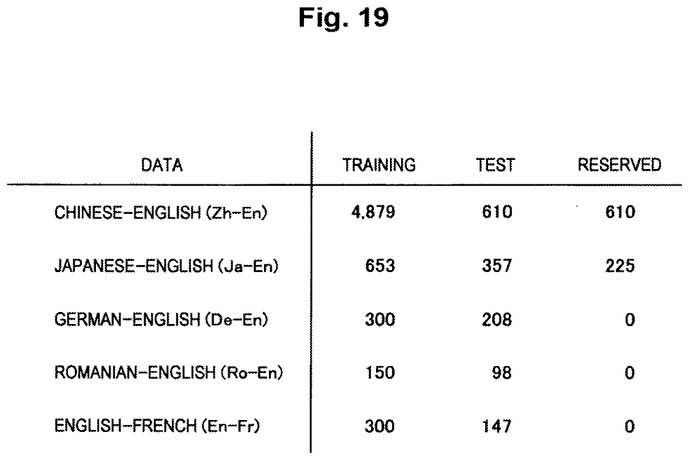

FIG. 19 illustrates the number of sentences of training data and test data of correct answers (gold word alignment) of word alignments manually created for five language pairs of Chinese-English (Zh-En), Japanese-English (Ja-En), German-English (De-En), Romanian-English (Ro-En), and English-French (En-Fr). Further, the table of FIG. 19 also illustrates the number of pieces of data to be reserved.

In the experiment using the conventional technique [20], Zh-En data was used, and in the experiment of the conventional technique [9], De-En, Ro-En, En-Fr data was used. In the experiment according to the technique of the present embodiment, Ja-En data, which is one of the farthest (distant) language pairs in the world, was added.

The Zh-En data is obtained from GALE Chinese-English Parallel Aligned Treebank [12], and includes news broadcasting news, news wire, web data, and the like. In order to get as close as possible to the experimental conditions described in document [20], a parallel translation text obtained by dividing Chinese into characters (character tokenized) was used, and cleaning was performed by removing alignment errors, time stamps, and the like, and the text was randomly divided into training data of 80%, test data of 10%, and reserved of 10%.

KFTT word alignment data [14] was used as the Japanese to English data. The Kyoto Free Translation Task (KFTT) (http://www.phontron.com/kftt/index.html) is a manual translation of articles of Japanese Wikipedia related to Kyoto, and includes 440,000 sentences of training data, 1166 sentences of development data, and 1160 sentences of test data. The KFTT word alignment data is obtained by manually giving word alignment to a part of development data and test data of KFTT, and includes eight files of development data and seven files of test data. In the experiment of the technique according to the present embodiment, eight files of development data were used for training, four files of test data were used for testing, and the rest was reserved.

De-En, Ro-En, and En-Fr data are described in document [27], and the authors have published a script for preprocessing and evaluation (https://github.com/lilt/alignment-scripts). In the conventional technique [9], these data are used for experiments. The De-En data are described in document [24](https://www-i6.informatik.rwth-aachen.de/goldAlignment/). The Ro-En data and the En-Fr data were provided as a common task in the HLT-NAACL-2003 workshop on Building and Using Parallel Texts [13] (https://eecs.engin.umich.edu/). The En-Fr data is originally described in document [15]. The number of sentences of De-En, Ro-En, and En-Fr data is 508,248,447. For De-En and En-Fr, 300 sentences were used for training in the present embodiment, and for Ro-En, 150 sentences were used for training. The remaining sentences were used for testing.

<Evaluation Scale of Accuracy of Word Alignment>

In Example 2, the F1 score having the same weight for the precision and the recall is used as the evaluation scale of the word alignment.

[Math. 36]

F₁=2×P×R/(P+R) (36)

Some conventional studies report only an alignment error rate (AER, word error rate) [16], and thus the AER is also used for comparison between the conventional technique and the technique according to the present embodiment.

It is assumed that a correct answer word alignment (gold word alignment) created manually includes a secure alignment (sure, S) and a possible alignment (possible, P). However, S⊆P. The precision, the recall, and the AER of the word alignment A are defined as follows.

$$[ Math . 37 ]$$

$$Precision ( A , P ) = \frac{\vert P ∩ A \vert}{\vert A \vert} \qquad ( 37 )$$

$$[ Math . 38 ]$$

$$Recall ( A , S ) = \frac{\vert S ∩ A \vert}{\vert S \vert} \qquad ( 38 )$$

$$[ Math . 39 ]$$

$$AER ( S , P , A ) = 1 - \frac{\vert S ∩ A \vert + \vert P ∩ A \vert}{\vert S \vert + \vert A \vert} \qquad ( 39 )$$

Document [7] points out that the AER has defects because of too much emphasis on the precision. That is, when only a small number of alignment points having a high certainty factor for the system are output, an unreasonably small (=good) value can be output. Therefore, the AER should not be used. However, among the conventional methods, document [9] uses the AER. If a distinction between sure and possible is made, it is necessary to note that the recall and the precision are different from those in a case where the distinction between sure and possible is not made. Among the five pieces of data, De-En and En-Fr have distinction between sure and possible.

<Comparison of Accuracy of Word Alignment>

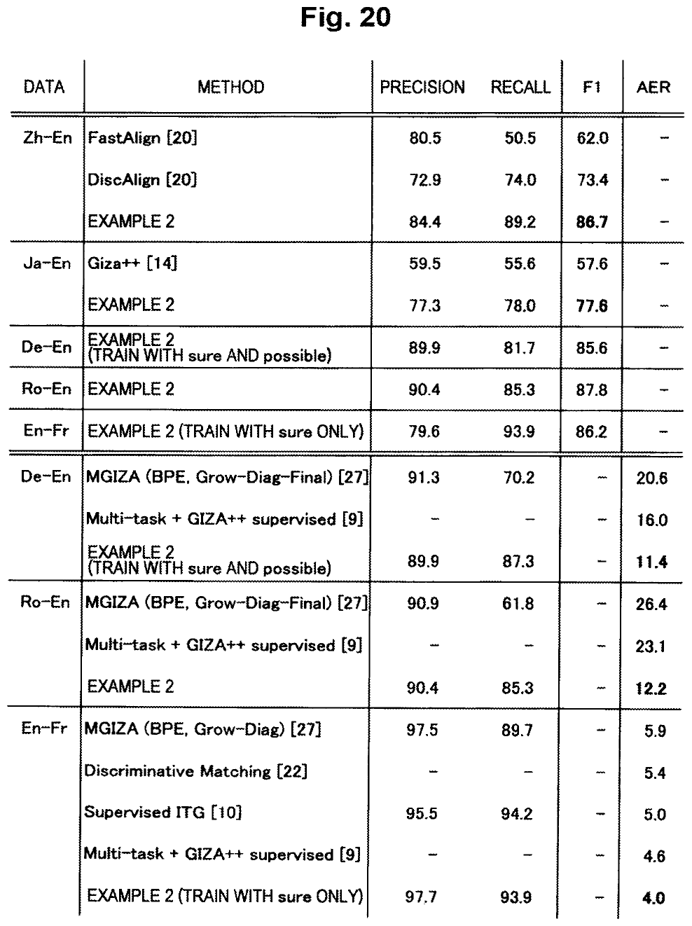

FIG. 20 illustrates a comparison between a technique according to Example 2 and conventional techniques. For all five data, the technique according to Example 2 is superior to all the conventional techniques.

For example, in the Zh-En data, the technique according to Example 2 achieves an F1 score of 86.7, which is 13.3 points higher than the F1 score 73.4 of DiscAlign reported in document [20], which is the current highest state-of-the-art of word alignment by supervised learning. The method of document [20] uses four million sentence pairs of parallel translation data to pre-train a translation model, whereas the technique according to Example 2 does not require parallel translation data for pre-training. For the Ja-En data, Example 2 achieves an F1 score of 77.6, which is 20 points higher than the F1 score of 57.8 for GIZA++.

Regarding the De-EN, Ro-EN, and En-Fr data, since the method of the document [9] that has achieved the highest current highest state-of-the-art of word alignment by unsupervised learning reports only the AER, evaluation is performed with the AER also in the present embodiment. The AERs for MGIZA and other conventional methods for the same data are also described for comparison [22, 10].

In the experiment, the word alignment points of both sure and possible are used as the De-En data for training of the present embodiment, but only sure is used as the En-Fr data because there is a lot of noise. The AERs of the present embodiment for the De-En, Ro-En, and En-Fr data are 11.4, 12.2, and 4.0, which are clearly lower than the method of document [9].

Comparing the accuracy of the supervised learning and the accuracy of the unsupervised learning is obviously unfair as the evaluation of the machine learning. The purpose of this experiment is to illustrate that supervised word alignment is a practical method for obtaining high accuracy, since accuracy above the conventionally reported highest accuracy can be achieved using a smaller amount of correct answer data (about 150 sentences to 300 sentences) than the correct answer data originally manually created for evaluation.

### Example 2: Effect of Symmetrization

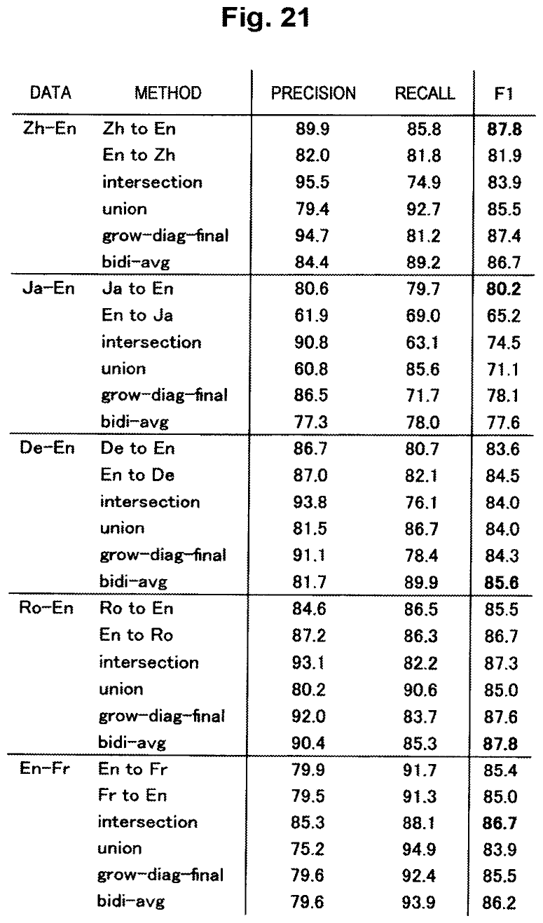

In order to illustrate the effectiveness of the bidirectional average (bidi-avg), which is the method of the symmetrization in Example 2, FIG. 21 illustrates the word alignment accuracy of bidirectional prediction, intersection, union, grow-diag-final, and bidi-avg. The alignment word alignment accuracy is greatly affected by the orthography of the target language. In a language such as Japanese or Chinese in which no space is put between words, the accuracy of prediction of a span to English is higher than the accuracy of prediction of a span from English. In such a case, grow-diag-final is better than bidi-avg. On the other hand, in languages with spaces between words such as German, Romanian, and French, there is no significant difference between span prediction to English and span prediction from English, and grow-diag-final is better than bidi-avg. In the En-Fr data, the intersection has the highest accuracy, which is considered to be because the data originally has a lot of noise.

<Importance of Original Language Context>

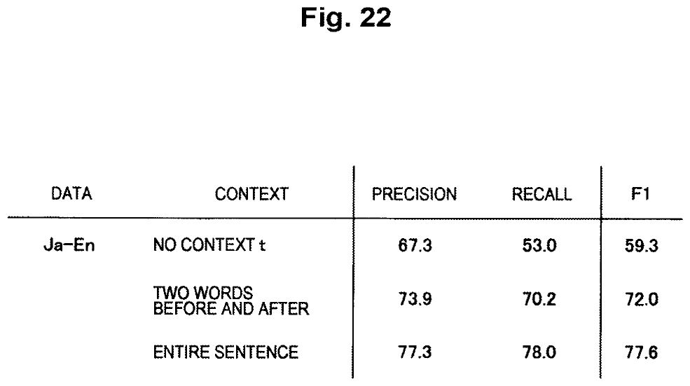

FIG. 22 illustrates a change in word alignment accuracy when the magnitude of the context of the source language word is changed. Here, Ja-En data was used. It can be seen that the context of the source language word is very important for prediction of the target language span.

In the absence of context, the F1 score for Example 2 is 59.3, which is only slightly higher than the F1 score 57.6 for GIZA++. However, giving only the context of two words before and after results in 72.0, and giving the entire sentence as the context results in 77.6.

<Learning Curve>

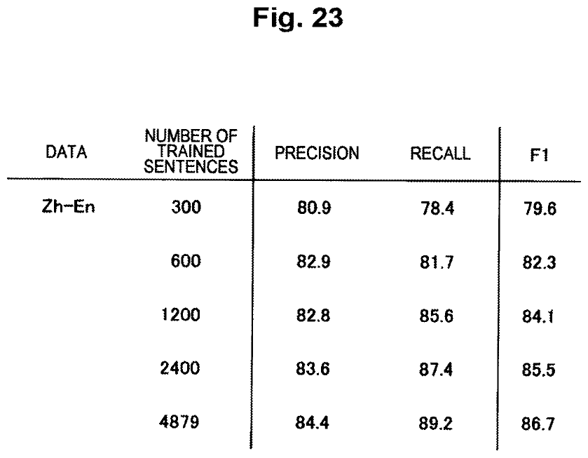

FIG. 23 illustrates a learning curve of the word alignment method of Example 2 in a case where the Zh-En data is used. It is a matter of course that the accuracy is higher as the number of pieces of learning data is larger, but the accuracy is higher than that of the conventional supervised learning method even with a small number of pieces of learning data. The F1 score 79.6 of the technique according to the present embodiment when the learning data is 300 sentences is 6.2 points higher than the F1 score 73.4 when the method of document [20], which is the current highest state-of-the-art, trains using 4800 sentences.

### Summary of Example 2

As described above, in Example 2, the problem of obtaining the word alignment in two sentences translated from each other is regarded as a set of problems (cross-language span prediction) of independently predicting a word of a sentence of another language aligning with each word of a sentence of a certain language or a continuous word string (span), and the cross-language span predictor is trained (supervised learning) from a small number of pieces of correct answer data created manually by using the neural network, thereby achieving highly accurate word alignment.

The cross-language span prediction model is created by finetuning a pre-trained multilingual model created using only respective monolingual texts for a plurality of languages, the finetuning using a small number of pieces of correct answer data created manually. As compared with a conventional method based on a machine translation model such as Transformer, which requires several one million pairs of parallel translation data for pre-training of a translation model, the technique according to the present embodiment can be applied to a language pair or a region in which the amount of available parallel translation sentences is small.

In Example 2, if there are about 300 sentences of correct answer data created manually, word alignment accuracy exceeding that of conventional supervised learning and unsupervised learning can be achieved. According to the document [20], since correct answer data of about 300 sentences can be created in several hours, word alignment with high accuracy can be obtained at a realistic cost according to the present embodiment.

In addition, in Example 2, the word alignment is converted into a general-purpose problem of a cross-language span prediction task in the SQuAD v2.0 format, and thus it is possible to easily incorporate a multilingual pre-trained model and a state of the art technique related to question answering, and to improve performance. For example, it is possible to use XLM-RoBERTa [2] to create a more accurate model or distilmBERT [19] to create a compact model that moves with less computer resources.

### REFERENCE DOCUMENT OF EXAMPLE 2

[1] Peter F. Brown, Stephen A. Della Pietra, Vincent J. Della Pietra, and Robert L. Mercer. The Mathematics of Statistical Machine Translation: Parameter Estimation. Computational Linguistics, Vol. 19, No. 2, pp. 263-311, 1993.
[2] Alexis Conneau, Kartikay Khandelwal, Naman Goyal, Vishrav Chaudhary, Guillaume Wenzek, Francisco Guzm'an, Edouard Grave, Myle Ott, Luke Zettlemoyer, and Veselin Stoyanov. Unsupervised Cross-lingual Representation Learning at Scale. arXiv:1911.02116, 2019.
[3] Alexis Conneau and Guillaume Lample. Cross-lingual Language Model Pretraining. In Proceedings of NeurIPS-2019, pp. 7059-7069, 2019.
[4] John DeNero and Dan Klein. The Complexity of Phrase Alignment Problems. In Proceedings of the ACL-2008, pp. 25-28, 2008.
[5] Jacob Devlin, Ming-Wei Chang, Kenton Lee, and Kristina Toutanova. BERT: Pre-training of Deep Bidirectional Transformers for Language Understanding. In Proceedings of the NAACL-2019, pp. 4171-4186, 2019.
[6] Chris Dyer, Victor Chahuneau, and Noah A. Smith. A Simple, Fast, and Effective Reparameterization of IBM Model 2. In Proceedings of the NAACL-HLT-2013, pp. 644-648, 2013.
[7] Alexander Fraser and Daniel Marcu. MeasuringWord Alignment Quality for Statistical Machine Translation. Computational Linguistics, Vol. 33, No. 3, pp. 293-303, 2007.
[8] Qin Gao and Stephan Vogel. Parallel Implementations of Word Alignment Tool. In Proceedings of ACL 2008 workshop on Software Engineering, Testing, and Quality Assurance for Natural Language Processing, pp. 49-57, 2008.
[9] Sarthak Garg, Stephan Peitz, Udhyakumar Nallasamy, and Matthias Paulik. Jointly Learning to Align and Translate with Transformer Models. In Proceedings of the EMNLP-IJCNLP-2019, pp. 4452-4461, 2019.
[10] Aria Haghighi, John Blitzer, John DeNero, and Dan Klein. Better Word Alignments with Supervised ITG Models. In Proceedings of the ACL-2009, pp. 923-931, 2009.
[11] Philipp Koehn, Hieu Hoang, Alexandra Birch, Chris Callison-Burch, Marcello Federico, Nicola Bertoldi, Brooke Cowan, Wade Shen, Christine Moran, Richard Zens, Chris Dyer, Ondrej Bojar, Alexandra Constantin, and Evan Herbst. Moses: Open Source Toolkit for Statistical Machine Translation. In Proceedings of the ACL-2007, pp. 177-180, 2007.
[12] Xuansong Li, Stephen Grimes, Stephanie Strassel, Xiaoyi Ma, Nianwen Xue, Mitch Marcus, and Ann Taylor. GALE Chinese-English Parallel Aligned Treebank-Training. Web Download, 2015. LDC2015T06.
[13] Rada Mihalcea and Ted Pedersen. An Evaluation Exercise for Word Alignment. In Proceedings of the HLT-NAACL 2003 Workshop on Building and Using Parallel Texts: Data Driven Machine Translation and Beyond, pp. 1-10, 2003.
[14] Graham Neubig. Kyoto Free Translation Task alignment data package. http://www.phontron.com/kftt/, 2011.
[15] Franz Josef Och and Hermann Ney. Improved Statistical Alignment Models. In Proceedings of ACL-2000, pp. 440-447, 2000.
[16] Franz Josef Och and Hermann Ney. A Systematic Comparison of Various Statistical Alignment Models. Computational Linguistics, Vol. 29, No. 1, pp. 19-51, 2003.
[17] Pranav Rajpurkar, Robin Jia, and Percy Liang. Know What You Don't Know: Unanswerable Questions for SQuAD. In Proceedings of the ACL-2018, pp. 784-789, 2018.
[18] Pranav Rajpurkar, Jian Zhang, Konstantin Lopyrev, and Percy Liang. SQuAD: 100,000+Questions for Machine Comprehension of Text. In Proceedings of EMNLP-2016, pp. 2383-2392, 2016.
[19] Victor Sanh, Lysandre Debut, Julien Chaumond, and Thomas Wolf. DistilBERT, a distilled version of BERT: smaller, faster, cheaper and lighter. arXiv:1910.01108, 2019.
[20] Elias Stengel-Eskin, Tzu ray Su, Matt Post, and Benjamin Van Durme. A Discriminative Neural Model for Cross-Lingual Word Alignment. In Proceedings of the EMNLP-IJCNLP-2019, pp. 910-920, 2019.
[21] Akihiro Tamura, Taro Watanabe, and Eiichiro Sumita. Recurrent Neural Networks for Word Alignment Model. In Proceedings of the ACL-2014, pp. 1470-1480, 2014.
[22] Ben Taskar, Simon Lacoste-Julien, and Dan Klein. A Discriminative Matching Approach to Word Alignment. In Proceedings of the HLT-EMNLP-2005, pp. 73-80, 2005.
[23] Ashish Vaswani, Noam Shazeer, Niki Parmar, Jakob Uszkoreit, Llion Jones, Aidan N. Gomez, Lukasz Kaiser, and Illia Polosukhin. Attention Is All You Need. In Proceedings of the NIPS 2017, pp. 5998-6008, 2017.
[24] David Vilar, Maja Popovi'c, and Hermann Ney. AER: Do we need to “improve” our alignments? In Proceedings of IWSLT-2006, pp. 2005-212, 2006.
[25] Stephan Vogel, Hermann Ney, and Christoph Tillmann. HMM-Based Word Alignment in Statistical Translation. In Proceedings of COLING-1996, 1996.
[26] Nan Yang, Shujie Liu, Mu Li, Ming Zhou, and Nenghai Yu. Word Alignment Modeling with Context Dependent Deep Neural Network. In Proceedings of the ACL-2013, pp. 166-175, 2013.
[27] Thomas Zenkel, Joern Wuebker, and John DeNero. Adding Interpretable Attention to Neural Translation Models Improves Word Alignment. arXiv:1901.11359, 2019.

(Supplementary Notes)

The present specification discloses at least an alignment device, a learning device, an alignment method, a program, and a storage medium of each of the following supplementary notes. Note that, in “a span prediction unit that uses a span prediction model created using data including a cross-domain span prediction problem and an answer to the span prediction problem, and predicts a span to be an answer to the span prediction problem” in the following Supplementary Notes 1, 6, and 10, the “including a cross-domain span prediction problem and an answer to the span prediction problem” relates to “data”, and “created using . . . data” relates to the “span prediction model”.

(Supplementary Note 1)

An alignment device including:
a memory; and
at least one processor connected to the memory, in which
the processor
generates a span prediction problem between first domain sequence information and second domain sequence information by receiving the first domain sequence information and the second domain sequence information as inputs, and
a span prediction unit that uses a span prediction model created using data including a cross-domain span prediction problem and an answer to the span prediction problem, and predicts a span to be an answer to the span prediction problem.

(Supplementary Note 2)

The alignment device according to Supplementary Note 1, in which
the span prediction model is a model obtained by performing additional training of a pre-trained model using the data.

(Supplementary Note 3)

The alignment device according to Supplementary Note 1 or 2, in which
sequence information in the first domain sequence information and the second domain sequence information is a document, and
the processor determines whether or not a sentence set of the first span and a sentence set of the second span align with each other, on the basis of a probability of predicting a second span by a question of a first span in span prediction from the first domain sequence information to the second domain sequence information and a probability of predicting the first span by a question of the second span in span prediction from the second domain sequence information to the first domain sequence information.

(Supplementary Note 4)

The alignment device according to Supplementary Note 3, in which
the processor generates an alignment of sentence sets between the first domain sequence information and the second domain sequence information by solving an integer linear programming problem in such a manner that a sum of costs of an alignment relationship of sentence sets between the first domain sequence information and the second domain sequence information is minimized.

(Supplementary Note 5)

A learning device including:
a memory; and
at least one processor connected to the memory, in which
the processor
generates data having a span prediction problem and an answer to the span prediction problem from alignment data having first domain sequence information and second domain sequence information, and
generates a span prediction model using the data.

(Supplementary Note 6)

An alignment method causing a computer to perform:
a problem generation step of generating a span prediction problem between first domain sequence information and second domain sequence information by receiving the first domain sequence information and the second domain sequence information as inputs; and
a span prediction step of using a span prediction model created using data including a cross-domain span prediction problem and an answer to the span prediction problem, and predicting a span to be an answer to the span prediction problem.

(Supplementary Note 7)

A learning method causing a computer to perform:
a problem answer generation step of generating data having a span prediction problem and an answer to the span prediction problem from alignment data having first domain sequence information and second domain sequence information; and
a learning step of generating a span prediction model using the data.

(Supplementary Note 8)

A program for causing a computer to function as the alignment device according to any one of Supplementary Notes 1 to 4.

(Supplementary Note 9)

A learning program for causing a computer to function as the learning device according to Supplementary Note 5.

(Supplementary Note 10)

A non-transitory storage medium storing a program executable by a computer to execute alignment processing, in which
the alignment processing includes
generating a span prediction problem between first domain sequence information and second domain sequence information by receiving the first domain sequence information and the second domain sequence information as inputs, and
using a span prediction model created using data including a cross-domain span prediction problem and an answer to the span prediction problem, and predicting a span to be an answer to the span prediction problem.

(Supplementary Note 11)

A non-transitory storage medium storing a program executable by a computer to execute learning processing, in which
the learning processing includes
generating data having a span prediction problem and an answer to the span prediction problem from alignment data having first domain sequence information and second domain sequence information, and
generating a span prediction model using the data.

Although the present embodiment has been described above, the present invention is not limited to such a specific embodiment, and various modifications and changes can be made within the scope of the gist of the present invention described in the claims.

### REFERENCE SIGNS LIST

100 Sentence alignment device
110 Cross-language span prediction model training unit
111 Sentence alignment data storage unit
112 Sentence alignment generation unit
113 Sentence alignment pseudo correct answer data storage unit
114 Cross-language span prediction problem answer generation unit
115 Cross-language span prediction pseudo correct answer data storage unit
116 Span prediction model training unit
117 Cross-language span prediction model storage unit
120 Sentence alignment execution unit
121 Cross-language span prediction problem generation unit
122 Span prediction unit
123 Sentence alignment generation unit
200 Pre-training device
210 Multilingual data storage unit
220 Multilingual model training unit
230 Pre-trained multilingual model storage unit
300 Word alignment device
310 Cross-language span prediction model training unit
311 Word alignment correct answer data storage unit
312 Cross-language span prediction problem answer generation unit
313 Cross-language span prediction correct answer data storage unit
314 Span prediction model training unit
315 Cross-language span prediction model storage unit
320 Word alignment execution unit
321 Cross-language span prediction problem generation unit
322 Span prediction unit
323 Word alignment generation unit
400 Pre-training device
410 Multilingual data storage unit
420 Multilingual model training unit
430 Pre-trained multilingual model storage unit
1000 Drive device Recording medium
1002 Auxiliary storage device
1003 Memory device
1004 CPU
1005 Interface device
1006 Display device
1007 Input device

1. An alignment device, comprising:
a memory; and
a processor configured to execute
generating a span prediction problem between first domain sequence information and second domain sequence information by receiving the first domain sequence information and the second domain sequence information as inputs; and
using a span prediction model created using data including a cross-domain span prediction problem and an answer to the span prediction problem, and predicting a span to be an answer to the span prediction problem.

2. The alignment device according to claim 1, wherein the span prediction model is a model obtained by performing additional training of a pre-trained model using the data.

3. The alignment device according to claim 1, wherein sequence information in the first domain sequence information and the second domain sequence information is a document, and
wherein the processor further executes determining whether or not a sentence set of the first span and a sentence set of the second span align with each other, on a basis of a probability of predicting a second span by a question of a first span in span prediction from the first domain sequence information to the second domain sequence information and a probability of predicting the first span by a question of the second span in span prediction from the second domain sequence information to the first domain sequence information.

4. The alignment device according to claim 3, wherein the processor generates an alignment of sentence sets between the first domain sequence information and the second domain sequence information by solving an integer linear programming problem in such a manner that a sum of costs of an alignment relationship of sentence sets between the first domain sequence information and the second domain sequence information is minimized.

5. A learning device, comprising:
a memory; and
a processor configured to execute
generating data having a span prediction problem and an answer to the span prediction problem from alignment data having first domain sequence information and second domain sequence information; and
generating a span prediction model using the data.

6. An alignment method executed by an alignment device including a memory and a processor, the alignment method comprising:
generating a span prediction problem between first domain sequence information and second domain sequence information by receiving the first domain sequence information and the second domain sequence information as inputs; and
using a span prediction model created using data including a cross-domain span prediction problem and an answer to the span prediction problem, and predicting a span to be an answer to the span prediction problem.

7. (canceled)

8. A non-transitory computer-readable recording medium having computer-readable instructions stored thereon, which, when executed, cause a computer to function as the alignment device according to claim 1.

9. A non-transitory computer-readable recording medium having computer-readable instructions stored thereon, which, when executed, cause a computer to function as the learning device according to claim 5.
